(19) United States
(12) Patent Application Publication
(10) Pub. No.: US 2007/0214467 A1
(43) Pub. Date: Sep. 13, 2007

(54) Optical Information Recording Carrier

(75) Inventors: Kenichi Fukuda, Kanagawa (JP); Katsuro Nagaoka, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/596,870

(22) PCT Filed: May 16, 2005
(86) PCT No.: PCT/JP05/09292

§ 371 Date: Nov. 17, 2006

(30) Foreign Application Priority Data
May 19, 2004 (JP) 2004-149566

(51) Int. Cl. G11B 7/24

(52) U.S. Cl. 720/718; 977/849

(57) ABSTRACT

An optical information recording carrier comprising: a back layer; a support; a recording layer; and a light transmitting layer, in this order, wherein each of the back layer and the light transmitting layer comprises at least one substrate film, wherein a difference between a hygroscopic expansion coefficient of the at least one substrate film and a hygroscopic expansion coefficient of the support is 10 ppm/% RH or more.

### TECHNICAL FIELD

The present invention relates to an optical information recording carrier which is able to record and reproduce by optical means, magnetic means, etc. and, more particularly, it relates to an optical information recording carrier which is able to conduct reproduction by an optical means.

### BACKGROUND ART

With regard to an optical information recording carrier of a write-once type where information is possible only once by laser beam, a recording carrier called CD-R has been widely known. CD-R has an advantage that it is able to be reproduced using a commercially available CD player and, recently, its demand has been increasing as a result of diffusion of personal computers. As an information recording carrier where a record in large capacity is possible by CD-R, a digital versatile disk (DVD-R) of a write-once type dealing with telerecording of digital high-definition television, etc. has been in practical use as well.

With regard to the optical information recording carrier of a write-once type as such, that having a structure where an optical reflection layer comprising Au or the like, a recording layer comprising an organic compound and a light-transmitting layer which protects the said recording layer (including an adhesive layer for adhering to the recording layer and being sometimes called “a cover layer”) are successively layered on a disk-shaped support has been known for example and, when laser beam is irradiated from the side of the light-transmitting layer, recording and reproduction are able to be carried out. Recording of the information to the optical information recording carrier of a write-once type is conducted in such a manner that a laser beam irradiating part of a recording layer absorbs the light and is locally deformed by heating (such as production of pits). On the other hand, reproduction of the information is usually conducted in such a manner that laser beams having the same wavelength as laser beams for recording is irradiated to an optical information recording carrier of a write-once type and the difference in reflectance of the area where the recording layer is deformed by heating (recorded part) and that of a non-deformed site (non-recorded part) is detected.

Recently, network such as internet and high-definition TV have been rapidly diffusing. Broadcasting of HDTV (high-definition television) has started as well. Under such circumstances, there is a need for an optical information recording carrier of a high capacity which is able to record image information at a low cost and in a simple and convenient manner. Although the above-mentioned DVD-R well plays a role as a recording carrier of a high capacity at present, there has been an increasing demand for making capacity and density high and development of recording carriers meeting with such a requirement is also necessary. For such a purpose, as an optical information recording carrier, development for a recording carrier having much more capacity which is able to conduct a high density recording by further short wavelength has been conducted. Particularly, an optical information recording carrier of a write-only type which is able to record information only once is increasing for its frequency in use as a long-term storage of information of large capacity or as a backup and, therefore, there has been a strong demand for its development.

Usually, making density of an optical information recording carrier high is able to be achieved by means of making a beam spot small by making wavelength of laser for recording and reproduction short and by making NA (numerical aperture) of objective lens used for the pickup high. Recently, there has been a quick development from a red semiconductor laser where wavelengths are 680 nm, 650 nm and 635 nm to a bluish violet semiconductor laser (hereinafter, referred to as bluish violet laser) where wavelength are 400 nm to 500 nm whereby recording of more ultrahigh density is possible and development for an optical information recording carrier corresponding thereto has been carried out as well. Particularly since a bluish violet laser has been marketed, development of an optical recording system utilizing the bluish violet laser and a high NA pickup has been investigated and an optical information recording carrier of a writable type and an optical recording system having a recording system in which the phase changes has been put on the market already (refer, for example, to Collected Paper for Presentation at the International Symposium of Optical Memory (ISOM 2000), pages 210 to 211). As a result thereof, some fruitful results for the problem of making density in an optical information recording carrier of a writable type high have been achieved already.

In an optical information recording carrier used for an optical recording system utilizing a bluish violet laser and a high NA pickup as mentioned above, it is preferred that the length between an information recording carrier surface to which laser beam is irradiated and a recording layer (i.e., light transmitting layer) is made thin for focusing the objective lens of a high NA when the bluish violet laser beam is irradiated to the recording layer. Therefore, thickness of a light transmitting layer is set as 100 μm in the standards therefor.

Incidentally, in an optical recording medium, there are some cases where skew of an optical recording carrier substance to an optical axis (hereinafter, referred to as skew) is resulted and that affects on a signal characteristic.

There are some cases where amount of absorbed water in a support changes as a result of changes in environment such as temperature and humidity and, due to absorption of water as such, the support expands and skew is generated. As such, the skew caused by changes in environment, particularly caused by water absorption, is a phenomenon which is often noted in an optical recording medium having an asymmetric structure where only one side of the support is a signal side. That is because, in an optical recording medium of an asymmetric structure as above, water absorbing properties on both sides of the support are different. The skew caused by absorption of water as such is generated under a transient circumstance such as water absorption and water desorption and has a property that, when an environment is stabilized, it returns to the original state.

In an optical recording carrier of an asymmetric structure, there have been many proposals for improvement of warp due to an asymmetric property of expansion by absorption of moisture caused by such a support. In the above construction where thickness of the light transmitting layer is made thin, a reflection layer by a metal film is formed on one side of the support and the reflection layer also acts as a moisture-proof layer. As a result, there is a problem that coming-in and coming-out of moisture in a support due to changes in humidity environment take place from the side of a support where no reflection layer is formed whereby the recording medium is warped and recording of information becomes difficult.

In order to improve that, there are disclosures where a moisture-proof layer is formed on the front side which is an opposite side of a support so that amount of permeated water to the support is suppressed (refer, for example, Japanese Utility Model Laid-Open No. 05/033,319, WO 99/00794 and Japanese Patent Laid-Open No. 2001/143,325).

There is also a disclosure where the above problem is solved using a support having a low moisture absorbing rate (Japanese Patent Laid-Open No. 2003/077,181).

In a recording carrier where a light transmitting layer is layered on a support, there is a problem of skew caused by the difference in expansion coefficients upon moisture absorption between a support and a plastic substrate film of the light transmitting layer. Unlike a skew generated in a short period caused by the above-mentioned support per se, the skew does not return to the original state even when the environment becomes stable provided that the temperature for preservation is different from the firstly set one. The skew as such causes a problem of warping in a record carrier when materials for a support and a substrate film for light transmitting layer are different and when 10 ppm/% RH or more difference is available in the expansion coefficient upon moisture absorption. The more the difference in the expansion coefficient upon moisture absorption, the more the warp of the optical information recording carrier and writing and reproduction become difficult.

In order to prevent the warp caused by changes in heat and humidity, it is generally preferred to use a material having similar heat/humidity expansion coefficient of optical disk as a substrate film for a light transmitting layer and, usually, a material having the same quality as the said support is used. Therefore, since polycarbonate is generally used as a support for an optical disk at present, investigations have been conducted mostly for polycarbonate film having no optical anisotropy prepared by a flow-spread method as a substrate film for the light transmitting layer. Therefore, the problem has not been revealed.

However, since a polycarbonate film prepared by a flow-spread means is very expensive, it is a big factor for increasing a cost for a high-density optical disk using a bluish violet laser beam and there has been a demand for less expensive and useful solving means.

As one of the solving means, it has been considered to use a cellulose acylate film which is relatively cheap and has no optical anisotropy as a substitute for a polycarbonate film.

In this cellulose acylate film however, it has a high expansion coefficient upon moisture absorption as compared with a polycarbonate film and, therefore, this is a problem of warp due to the difference in expansion/shrinking caused by the difference between the substrate and the light transmitting layer against changes in temperature. For the practical application, it is necessary to overcome such a problem but, up to now, there has been no proposal for solving the problem of skew which is generated upon exposure for long time to the state of low humidity or high humidity using a plastic film (such as cellulose acetate film) as a substrate having different expansion coefficient upon moisture absorption from a support comprising polycarbonate.

### DISCLOSURE OF THE INVENTION

An object of the present invention relates is to provide an information recording carrier being able to reproduce information signal by an optical means in which stability upon storage is good, no warp is resulted in an optical recording medium particularly to changes in humidity, both good recording and reproduction are able to be conducted, cost is cheap and usefulness is available.

Another object of the present invention is to provide an information recording carrier where generation of damage on the surface for incidence of light is effectively prevented and stability on preservation is also good.

In order to achieve the above-mentioned objects, the present inventors have conducted an intensive investigation and, as a result, they have found that the above objects are able to be achieved according to the following constitutions. Thus, the present invention relates to an optical information recording carrier having the following constitutions and to a method for recording as well as regenerating of optical information using the same.

(1) An optical information recording carrier comprising:

a back layer;

a support;

a recording layer; and

a light transmitting layer, in this order,

wherein each of the back layer and the light transmitting layer comprises at least one substrate film,

wherein a difference between a hygroscopic expansion coefficient of the at least one substrate film and a hygroscopic expansion coefficient of the support is 10 ppm/% RH or more.

(2) The optical information recording carrier as described in (1) above,

wherein the difference is 30 ppm/% RH or more.

(3) The optical information recording carrier as described in (1) or (2) above,

wherein the light transmitting layer has a thickness of 50 μm to 300 μm.

(4) The optical information recording carrier as described in any of (1) to (3) above,

wherein the recording layer is recorded by a light having a wavelength of 350 nm to 450 nm.

(5) The optical information recording carrier as described in any of (1) to (4) above,

wherein the support comprises a material containing a polycarbonate.

(6) The optical information recording carrier as described in any of (1) to (5) above,

wherein at least one of the at least one substrate film is a cellulose acylate film.

(7) The optical information recording carrier as described in any of (1) to (6) above,

wherein at least one of the at least one substrate film contain(s) at least one deterioration preventing agent selected from

(A) a decomposing agent for peroxide,

(B) a radical chain terminator,

(C) a metal inactivating agent and

(D) an acid capturing agent.

(8) The optical information recording carrier as described in any of (1) to (7) above,

wherein the light transmitting layer further comprises a hardened film containing a resin hardened by active energy ray in a surface of the light transmitting layer.

(9) The optical information recording carrier as described in any of (1) to (8) above,

wherein the back layer further comprises a hardened film containing a resin hardened by active energy ray in a surface of the back layer.

(10) The optical information recording carrier as described in (8) or (9) above,

wherein the hardened film contains inorganic particles having an average particle size of 5 nm to 200 nm.

(11) The optical information recording carrier as described in any of (1) to (10) above,

wherein a contact angle between the surface of the light transmitting layer and a water is 90° or more.

(12) The optical information recording carrier as described in any of (1) to (11) above,

wherein a pencil hardness of the surface of the light-transmitting layer is H or more.

(13) An optical information recording method which comprises recording an information signal to a recording layer of an optical information recording carrier as described in any of (1) to (12) above, by using a light having a wavelength of 350 nm to 450 nm.

(14) An optical information reproduction method which comprises reproducing an information signal from a recording layer of an optical information recording carrier as described in any of (1) to (12) above, by using a light having a wavelength of 350 nm to 450 nm.

### BRIEF DESCRIPTION OF THE DRAWING

FIG. 1 is an outline of a schematic cross-sectional view of an optical information recording carrier (optical disk) prepared in the present Examples.

### BEST MODE FOR CARRYING OUT THE INVENTION

An information recording carrier of the present invention will now be further illustrated as hereinafter. Incidentally, in the present specification, expression reading “(numerical value 1) to (numerical value 2)” for values of physical property, characteristics, etc. shall mean “from (numerical value 1) inclusive to (numerical value 2) inclusive”.

The information recording carrier of the present invention is an information recording carrier where information signal is able to be reproduced by an optical means. The information recording carrier of the present invention fundamentally comprises support, recording layer and light transmitting layer. The information recording carrier of the present invention is characterized in that at least one film where difference from the support in expansion coefficient upon absorption of moisture is 10 ppm/% RH or more is applied to the back of the said support and the said light transmitting layer.

In the information recording carrier of the present invention, each of the constituting elements may be exchanged each other or combined within such an extent that the gist of the invention is not inhibited. Although it is necessary that at least one element is present, each element may be present as plural layers or one layer may be composed of plural layers having different compositions or characteristics. To be more specific, it is possible to install each two recording layers and light-transmitting layers on one side of a support in such a manner of support/recording layer/light-transmitting layer/recording layer/light-transmitting layer.

Besides the above-mentioned layers, it is also possible to install known electrostatic preventing layer, lubrication layer, protective layer, reflective layer, etc. It is further possible a label printing is applied to an opposite side to a recording layer of a support.

The information recording carrier of the present invention may be installed inside a cartridge. There is no limitation for its size and, in the case of a disk-shaped information recording carrier, various sizes such as 30 to 300 mm in diameter may be adopted. Diameter may be 32, 51, 65, 80, 88, 120, 130, 200, 300 mm, etc.

In the information recording carrier of the present invention, a support is a base having a function where recording layer, light-transmitting layer, etc. which will be mentioned later are mechanically held.

As to a material which constitutes the support, synthetic resin, ceramic, metal, etc. may be used although they are non-limitative.

With regard to the representative examples of the synthetic resin, preferably used ones are various kinds of thermoplastic resin and thermosetting resin as well as various kinds of radiosetting resin (including resins which are hardened by ultraviolet ray and visible ray) such as polycarbonate, polymethyl methacrylate, polystyrene, a copolymer of polycarbonate with polystyrene, polyvinyl chloride, alicyclic polyolefin and polymethylpentene and they may be synthetic resins where metal powder or ceramic powder is compounded.

With regard to representative examples of ceramic, soda lime glass, soda aluminosilicate glass, borosilicic acid glass, quartz glass, etc. may be used.

With regard to metal, aluminum, copper, iron, etc. may be used although they are non-limitative.

With regard to the above-mentioned constituting material, polycarbonate and amorphous polyolefin are preferred in view of resistance to moisture, dimensional stability and cost and polycarbonate is most preferred.

With regard to thickness of a support, 0.3 to 3 mm is preferred in view of necessity for mechanical holding of other layers. It is preferably 0.6 to 2 mm and that within a range of 1.1 mm±0.3 mm is used most advantageously.

On the surface of a support, grooves for tracking or unevenness (pregrooves) showing information such as address signal are usually formed. It is preferred that such pregrooves are directly formed on a support when a resin material such as polycarbonate is subjected to an injection molding or an extrusion molding. It is also possible that formation of pregrooves is achieved by installment of a pregroove layer.

With regard to a material for pregrooves, a mixture of at least one kind of monomer (or oligomer) of mono-, di-, tri-, tetra-, penta- and hexa-acrylate of polyol and an initiator for optical polymerization may be used although that is non-limitative.

Formation of a pregroove layer is carried out in the following manner for example. Thus, firstly, the above mixed solution comprising the acrylate and polymerization initiator is applied on a mother mold (stamper) which is made precisely, then a support is placed on the layer of the applied solution and ultraviolet ray is irradiated via the support or the mother mold to harden the applied layer whereupon the support and the applied layer are adhered. After that, the support is detached from the mother mold to form a pregroove layer. Thickness of the pregroove layer is usually within a range of 0.01 to 100 μm and, preferably, within a range of 0.05 to 50 μm.

In the present invention, a track pitch of the pregrooves of a support is preferably within a range of 200 to 400 nm and, more preferably, within a range of 250 to 350 nm.

Groove depth of the pregrooves is preferably within a range of 10 to 150 nm, more preferably within a range of 20 to 100 nm and, still more preferably, within a range of 30 to 80 nm. Its half width is preferably within a range of 50 to 250 nm and, more preferably, within a range of 100 to 200 nm.

When a light reflecting layer which will be mentioned later is installed in the information recording carrier of the present invention, it is preferred to form an undercoating layer on the surface of a support where the light reflecting layer is formed for a purpose of improvement of flatness and enhancement of adhesive force.

Examples of a material for the undercoating layer are a macromolecular substance such as polymethyl methacrylate, a copolymer of acrylic acid with methacrylic acid, a copolymer of styrene with maleic acid anhydride, polyvinyl alcohol, N-methylolacrylamide, a copolymer of styrene with vinyltoluene, chlorosulfonated polyethylene, nitrocellulose, polyvinyl chloride, chlorinated polyolefin, polyester, polyimide, a copolymer of vinyl acetate with vinyl chloride, a copolymer of ethylene with vinyl acetate, polyethylene, polypropylene and polycarbonate; and a surface reforming agent such as silane coupling agent.

The undercoating layer is able to be formed in such a manner that the above-mentioned material is dissolved or dispersed in an appropriate solvent to prepare an coating solution and the resulting coating solution is applied on the surface of a support by an coating means such as spin coat, dip coat or extrusion coat.

Usually, thickness of the undercoating layer is preferably within a range of 0.005 to 20 μm and, more preferably, within a range of 0.01 to 10 μm.

A light reflecting layer is freely installed between a support and a recording layer for a purpose of improvement in reflectivity in reproduction of information.

A light reflecting layer is able to be formed on a support by sputtering or ion plating of a light reflecting substance having a high reflectivity to laser beam. Usually, thickness of the light reflecting layer is made within a range of 10 to 300 nm and, preferably, within a range of 50 to 200 nm. Reflectivity of the light reflecting substance is preferred to be 70% or more.

Examples of the light reflecting substance having a high reflectivity are metal and half metal such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi as well as stainless steel. Such a light reflecting substance may be used solely or two or more thereof may be used jointly. Alternatively, it may be used as an alloy. Among those, preferred ones are Cr, Ni, Pt, Cu, Ag, Au, Al and stainless steel. Particularly preferred ones are Au, Ag, Al and an alloy thereof and the most preferred ones are Au, Ag and an alloy thereof.

On its back, a support of the present invention has at least one kind of film where the difference in expansion coefficient upon moisture absorption from the said support is 10 ppm/% RH or more, preferably 20 ppm/% RH or more and, particularly preferably, 30 ppm/% RH or more.

In the present specification, the term “expansion coefficient upon moisture absorption” means a rate of dimensional change of film when the environment is changed from 25° C. and 20% RH to 25° C. and 80% RH. Thus, when the size of the film at 25° C. and 20% RH is L₂₀ and the size of the film at 25° C. and 80% RH is L₈₀, [[(L₈₀−L₂₀)/L₂₀]/(80−20)]×10⁶ is an expansion coefficient upon moisture absorption (unit: ppm/% RH). It is able to be determined, for example, by cutting the film in a rectangle of 5 cm width and 28 cm length and by measuring the lengths of the film at 25° C. and 20% RH and at 25° C. and 80% RH.

In the present specification, the term “back of a support” means an opposite side of the support to the surface having a recording layer and a light transmitting layer and the above support and film may be adhered directly or united via a adhesive or the like.

With regard to the said film, a preferred one is that where the difference in the expansion coefficient upon moisture absorption from the support is 10 ppm/% RH or more and asymmetry of distribution of expansion coefficient upon moisture absorption is able to be made symmetric again. Although there is no particular limitation therefor so far as it has the similar expansion coefficient upon moisture absorption to the said substrate film, particularly preferred one is a cellulose derivative (especially, cellulose acylate). It is also possible that, if desired, the film is in a plural state comprising the same or different members.

In the information recording carrier of the present invention, a recording layer is a layer having a function of being able to record or rewrite the information by means of recording the information signal to the said layer by an optical or a magnetic recording means and it is also possible to reproduce the information signal from the said layer by an optical reproduction means (such as laser beam).

When an information recording carrier is an information recording carrier which is in an exclusively reproducing type, a high-reflectivity material is used for the recording layer while, when it is an information recording carrier of a recording/reproducing type, that which is selected from a material for dye recording, a material for phase change recording and a material for optical magnetic recording is used depending upon a recording or reproducing principle.

Thickness of the recording layer of the present invention is preferably 2 to 300 nm and that of 5 to 200 nm is used particularly advantageously. In the recording layer of the present invention, it is preferred to use light having wavelength of 350 nm to 450 nm or, preferably, 405 nm as an optical recording/reproducing means as such.

With regard to a material for light reflectivity used for the recording layer, gold, silver, etc. are used.

With regard to specific examples of recording material for a dye recording, cyanine dye, phthalocyanine dye, naphthalocyanine dye, azo dye, naphthoquinone dye, fulgide dye, polymethine dye, acridine dye, etc. may be used.

With regard to a recording material for a phase change recording, alloy of indium, antimony, tellurium, selenium, germanium, bismuth, vanadium, gallium, platinum, gold, silver, copper, tin, arsenic, etc. (the alloy includes oxide, nitride, carbide, sulfide, fluoride, etc.) may be used and the use of GeSbTe, AgInSbTe, CuAlTeSb, etc. is particularly preferred. It is also possible to use a layered membrane of indium alloy and tellurium alloy as a recording layer.

With regard to a recording material for an optical magnetic recording, alloy of terbium, cobalt, iron, gadolinium, chromium, neodymium, dysprosium, bismuth, palladium, samarium, holmium, praseodymium, manganese, titanium, palladium, erbium, ytterbium, lutetium, tin, etc. (the alloy includes examples of oxide, nitride, carbide, sulfide, fluoride, etc.) may be used and the use of that constituted from alloy of transition metal with rare earth element represented by TbFeCo, GdFeCo, DyFeCo, etc. is particularly preferred. It is also possible to use a alternatively layered membrane of cobalt and platinum as a recording layer.

It is also possible that such a recording layer is laminated together with the use of an auxiliary membrane such as alloy of silicon, tantalum, zinc, magnesium, calcium, aluminum, chromium, zirconium, etc. (including oxide, nitride and carbide) and a highly reflecting membrane (such as aluminum, gold and silver) for an object of improvement in reproduction output, improvement in rewriting frequency, improvement in stability upon preservation, etc.

It is preferred that a recording layer using a recording material for a dye recording contains a dye having a maximum absorption at the wavelength of laser beam used for reproduction and it is more preferred that the layer contains a dye having a maximum absorption at the wavelength range of 500 nm or shorter so that recording and reproduction by laser of such a wavelength range are possible.

Examples of the usable dye are cyanine dye, oxonol dye, dye of a metal complex type, azo dye, phthalocyanine dye, etc. Specific examples are the dyes mentioned in each of Japanese Patent Laid-Open Nos. 04/074,690, 08/127,174, 11/053,758, 11/334,204, 11/334,205, 11/334,206, 11/334,207, 2000/043,423, 2000/108,513 and 2000/158,818 and the dyes of triazole, triazine, cyanine, merocyanine, aminobutadiene, phthalocyanine, cinnamic acid, viologen, azo, oxonol benzoxazole, benzotriazole, etc. Dyes of cyanine, aminobutadiene, benzotriazole, phthalocyanine, etc. are preferred.

When a recording material for a dye recording is used, a recording layer is formed in such a manner that the above dye and, if desired, a binding agent are dissolved in an appropriate solvent to prepare an coating solution, the resulting coating solution is applied on the pregroove surface of the above support or on the surface of light reflecting layer and the resulting film is dried. It is also possible that various additives such as antioxidant, UV absorber, plasticizer and lubricant are added to the coating solution depending upon the object.

With regard to a method for a dissolving treatment of dye and binding agent, it is possible to apply a method such as treatment with ultrasonic wave, treatment with homogenizer, treatment with disper, treatment with sand mill and stirring treatment with stirrer.

Examples of the solvent for an coating solution are ester such as butyl acetate and Cellosolve acetate; ketone such as methyl ethyl ketone, cyclohexanone and methyl isobutyl ketone; chlorinated hydrocarbon such as dichloromethane, 1,2-dichloroethane and chloroform; amide such as dimethylformamide; hydrocarbon such as cyclohexane; ether such as tetrahydrofuran, ethyl ether and dioxane; alcohol such as ethanol, n-propanol, isopropanol, n-butanol and diacetone alcohol; fluorine-type solvent such as 2,2,3,3-tetrafluoropropanol; glycol ether such as ethylene glycol monomethyl ether, ethylene glycol monoethyl ether and propylene glycol monomethyl ether. With regard to the above-mentioned solvents, one of them may be used solely or two or more thereof may be appropriate used together by taking solubility of the dye and the binding agent used into consideration.

Examples of the binding agent are natural organic macromolecular substances such as gelatin, cellulose derivative, dextran, rosin and rubber; and synthetic organic macromolecular substances such as hydrocarbon resin (e.g., polyurethane, polyethylene, polypropylene, polystyrene and polystyrene), vinyl resin (e.g., polyvinyl chloride, polyvinylidene chloride and a copolymer of polyvinyl chloride with polyvinyl acetate), acrylate resin (e.g., methyl polyacrylate and methyl polymethacrylate) and initial condensate of thermosetting resin (e.g., polyvinyl alcohol, chlorinated polyethylene, epoxy resin, butyral resin, rubber derivative and phenol-formaldehyde resin). When a binding agent is jointly used as a material for the recording layer, the amount of the binding agent to the dye is preferably within a range of 0.01- to 50-fold (ratio by weight) and, more preferably, within a range of 0.1- to 5-fold. It is also possible to improve the stability upon preservation of the recording layer by containing the binding agent in the recording layer.

Concentration of the dye in the coating solution prepared as such is usually within a range of 0.01 to 10% by weight and, preferably, within a range of 0.1 to 5% by weight.

Examples of the coating method are spray method, spin coat method, dip method, roll coat method, blade coat method, doctor roll method and screen printing method.

With regard to coating temperature, although there is no particular problem when it is 23 to 50° C., it is preferred to be 24 to 40° C. and particularly preferred to be 25 to 37° C.

The recording layer may be either a single layer or a laminated layer. Thickness of the recording layer is usually within a range of 20 to 500 nm and, preferably, within a range of 50 to 300 nm.

The recording layer may contain various kinds of discoloration preventing agents for improving the resistance of the said recording layer to light.

As to the discoloration preventing agent, a singlet oxygen quencher is generally used. With regard to the singlet oxygen quencher, that which has been known already by being mentioned in publications such as patent specifications may be utilized. The specific examples thereof are those which are mentioned in Japanese Patent Laid-Open Nos. 58/175,693, 59/081,194, 60/018,387, 60/019,586, 60/019,587, 60/044,554, 60/044,555, 60/044,389, 60/044,390, 60/054,892, 60/047,069, 63/209,995, 04/025,492, 61/038,680 and 06/026,028, German Patent No. 350,399 and Nippon Kagaku Kaishi, page 1141, October, 1992.

Amount of the discoloration preventing agent such as a singlet oxygen quencher in the total solid of the recording layer is usually within a range of 0.1 to 50% by weight, preferably within a range of 0.5 to 45% by weight, more preferably within a range of 3 to 40% by weight and, particularly preferably, within a range of 5 to 25% by weight.

In order to improve the close adhesion to the light transmitting layer and to enhance the preservability of the dye, an intermediate layer (barrier layer) may be formed on the surface of the recording layer. The barrier layer is a layer comprising a material such as oxide, nitride, carbide and sulfide of one or more atoms from Zn, Si, Ti, Te, Sm, Mo, Ge, etc. The barrier layer may be a hybridized one such as ZnS—SiO₂. The barrier layer may be formed by means of sputtering, vapor-deposition ion plating, etc. and its thickness is preferred to be 1 to 100 nm.

In the information recording carrier of the present invention, the light transmitting layer has a function that, physically, the convergent reproduced light is introduced to a recording layer and, at the same time, it has a function of protecting the recording layer chemically and mechanically. It is preferred that the light transmitting layer of the present invention comprises a film which is constituted in a thin form than the thickness of the support.

Incidentally, the term “light-transmitting” in the present invention means that it is substantially transparent (transmittance being 70% or more or, preferably, 80% or more) to wavelength of the light of an optical means used for reproduction of recording (such as light of 600 to 800 nm and 350 to 450 nm).

The light transmitting layer of the present invention may have a substrate film (light-shielding film) and may appropriately contain adhesive layer, hard coat layer and anti-pollution layer.

With regard to a substrate film for the light transmitting film of the present invention, there is/are used one or more film(s) where the difference in expansion coefficient upon moisture absorption from the support is 10 ppm/% RH or more, preferably 20 ppm/% RH or more and, particularly preferably, 30 ppm/% RH or more. If desired, it is also possible that the said film is constituted from the same kind or from different kind and plural types.

Expansion coefficient upon moisture absorption of the substrate film may be adjusted by an appropriate selection of film material or type, quantity, etc. of the additive to the film. To be more specific, it is possible to use a cellulose acylate film containing a specific deterioration preventing agent, a cellulose acylate film where amount of organic solvent of a chlorine type is reduced, a cellulose acylate film containing a specific polyhydric alcohol and a cyclic polyolefin film or polycarbonate as a light transmitting film.

Further, it is preferred that the substrate film for the light transmitting layer of the present invention is not a film which is prepared by a manufacturing method including an elongation step. When it is prepared by a manufacturing method including an elongation step, optical anisotropy may sometimes happen in the elongated direction and, in such a case, the product is not preferred as a light transmitting layer for the information recording medium of the present invention. In addition, anisotropy in a thermal expansion may happen by elongation and that is not preferred in view of stability for a long-term preservation. To be specific, although a cellulose derivative (particularly, cellulose acylate) is preferred, that is not limitative so far as the difference in expansion coefficient upon moisture absorption from a support is 10 ppm/% RH or more and the above-mentioned object is able to be achieved.

For example, cellulose has a fundamental molecular structure of six-membered ring and, in the fundamental unit, there are three hydroxyl groups (OH). When hydroxyl groups of cellulose are esterified using glacial acetic acid, propionic acid, butyric acid, acetic anhydride, propionic anhydride, etc. cellulose acylate is able to be synthesized. Depending upon the synthetic condition, a part of or all of the three hydroxyl groups is/are able to be esterified. Among them, cellulose acylate where two or more hydroxyl groups are substituted is particularly made into a thin sheet by means of a flow-spread method using a solvent or a fusion-extrusion method and the said cellulose acylate has a characteristic that it is a transparent substance having a refractive index of about 1.5, has a small intrinsic double refraction and has a small dependency of angle of incidence of light. Although a cellulose acylate film prepared by application of tension to the cellulose acylate is tough, it gives a film where double refraction difference in longitudinal and transverse directions is suppressed as a result of intrinsic double refraction of the material whereby that is advantageous as a light transmitting film of the present invention.

It is preferred that, by adjusting the synthetic condition of cellulose derivative, transmittance at λ=350 to 450 nm of cellulose acylate is substantially transparent (transmittance: 70% or more; preferably 80% or more). That is because, although cellulose acylate may turn yellow or white depending upon the synthetic condition, reflectivity lowers whereby reproduced signal output is sometimes deteriorated when an information recording carrier is constituted using such a material.

There is a disadvantage that a cellulose acylate film as it is has low breaking strength and strength against bending and, especially under the state of low humidity, it is very fragile and is apt to be broken. In order to endow flexibility, low-molecular plasticizers have been added already. Examples thereof are triphenyl phosphate, tricresyl phosphate, triethyl phosphate, diphenyl biphenyl phosphate, etc. as a phosphate type, dimethyl phthalate, diethyl phthalate, dimethoxyethyl phthalate, etc. as a phthalate type, ethyl phthalylethyl glycol as a glycolate type, etc. and, besides those, toluene amide type ones, triacetine (glycerol triacetate), etc. have been used.

However, the above-listed plasticizers are low-molecular substances and their boiling point is not higher than 300° C. even in high-boiling ones. On the other hand, a cellulose acylate has been known as a polymer having little miscibility with other substances. It has been also known that, as mentioned above, even plasticizers having miscibility have a fatal disadvantage that boiling point is low and accordingly that, in the manufacture of film, transition of the plasticizer is intense and distribution of the plasticizer in the thickness direction of the resulting film is not uniform causing curl of the film or the plasticizer oozes out onto the surface of the film whereby the process thereafter is greatly disturbed. Under such circumstances, in order to overcome the above disadvantages or, in other words, in order to prepare a tough cellulose acylate film having big resistance to bending and tear strength at ambient temperature and low temperature, showing relatively unchanged tensile strength as compared with the case where low-molecular plasticizer is added and having an excellent optical transmittance, it has been attempted to use a macromolecular plasticizer such as polyester ether, polyester-urethane and polyester or a combination of such a macromolecular plasticizer with a low-molecular plasticizer by mixing with a cellulose acylate (refer, for example, to Japanese Patent Publication Nos. 47/000,760, 43/016,305 and 44/032,672 and Japanese Patent Laid-Open No. 02/292,342) and aimed object has been nearly achieved. It has been found however that, when such a support is used, there are disadvantages that stability under preservation for a long period significantly lowers and coloring, cleavage of molecular chain, etc. are apt to take place as compared with a support where only a low-molecular plasticizer (such as triphenyl phosphate) is contained.

In the present invention, it is preferred for the purpose that a cellulose acylate film containing a low-molecular plasticizer achieves stability for a long-term preservation that at least one member of deterioration preventing agent selected from

(A) a decomposing agent for peroxide

(B) a radical chain terminator

(C) a metal inactivating agent and

(D) an acid capturing agent

is contained in the said cellulose acylate film.

It is also preferred for achieving stability for a long-term preservation that amount of a solvent of an organic chlorine type contained in a cellulose acylate film is made 10 ppm or less or that an aliphatic polyhydric alcohol and polyhydric alcohol ester with one or more monocarboxylic acid(s) are contained in a cellulose acylate film.

A deterioration preventing agent which is able to be used in the present invention will be illustrated. Thus, in the present invention, compounds represented by the following formulae (A-I), (A-II) and (A-III) are preferred as (A) a decomposing agent for peroxide; a compound represented by the following formula (B-I) is preferred as (B) a radical chain terminator; compounds represented by the following formulae (C-I), (C-II) and (C-III) are preferred as (C) a metal inactivating agent; and compounds represented by the following formulae (D-I), (D-II), (D-III), (D-IV), (D-V), (D-VI), (D-VII) and (D-VIII) are preferred as (D) an acid capturing agent.

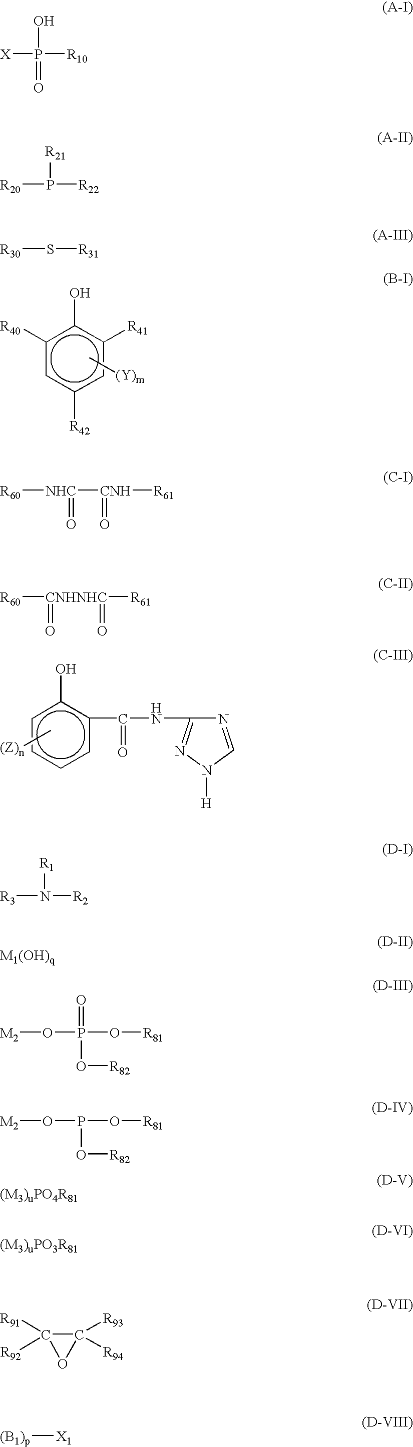

In the above formulae (A-I) to (D-VII), X is hydrogen atom, alkali metal or alkaline earth metal. R₁₀ is an alkyl group, an alkenyl group or an aryl group. R₂₀, R₂₁ and R₂₂ may be same or different and each is an alkyl group, an alkenyl group, an aryl group, an alkoxy group, an alkenoxy group, an aryloxy group, an alkylthio group, an alkenylthio group or an arylthio group. R₃₀ and R₃₁ may be same or different and each is an alkyl group, an alkenyl group or an aryl group. R₄₀ is an alkyl group. R₄₁, R₄₂ and Y may be same or different and each is hydrogen atom, an alkyl group, an alkenyl group, an aryl group, a heterocyclic group, an alkoxy group, an alkenyoxy group, an aryloxy group, a heterocyclic oxy group, an alkylthio group, an alkenylthio group, an arylthio group, hydroxyl group, an optionally substituted amino group, carbamoyl group, sulfamoyl group, an alkoxycarbonyl group, an aryloxycarbonyl group, halogen atom, nitro group, cyano group, an acyl group or an acyloxy group. m is an integer of 0 to 2. R₆₀ and R₆₁ may be same or different and each is an alkyl group, an alkenyl group, an aryl group or a heterocyclic group. Z is the same group as defined for Y and n is an integer of 0 to 4. When m is 2, the plural Y may be same or different and, similarly, when n is 2 to 4, the plural Z may be same or different. R₂₀ and R₂₁ or R₃₀ and R₃₁ may be bonded to form a five- to seven-membered ring.

R₁, R₂ and R₃ may be same or different and each is hydrogen atom, an aliphatic group, an aromatic group, a heterocyclic group or an amino group. At least two groups of R₁, R₂ and R₃ may be bonded each other to form a five- to eight-membered ring. R₁ and R₂ may form an unsaturated group in a cooperative manner each other and may form, by bonding to R₃, a five- to eight-membered ring. However, there is no case where all of R₁, R₂ and R₃ are hydrogen at the same time. M₁ is an alkali metal or an alkaline earth metal and q is 1 when M₁ is an alkali metal while, when M₁ is an alkaline earth metal, q is 2. R₈₁ and R₈₂ may be same or different and each is an alkyl group, an alkenyl group, an aryl group or a heterocyclic group. M₂ is an alkali metal and M₃ is alkali metal or alkaline earth metal. u is 2 when M₃ is an alkali metal while, when M₃ is an alkaline earth metal, u is 1. R₉₁, R₉₂, R₉₃ and R₉₄ may be same or different and each is hydrogen atom, an alkyl group, an alkenyl group, an aryl group or a heterocyclic group. At least two members of R₉₁, R₉₂, R₉₃ and R₉₄ may be bonded each other to form a five- to eight-membered ring.

The compounds which are represented by the formulae (A-I) to (D-VII) will be illustrated in more detail. X is hydrogen atom, an alkali metal (such as lithium, sodium and potassium) or an alkaline earth metal (such as calcium, barium and magnesium). The alkyl group defined by R₁₀, R₂₀, R₂₁, R₂₂, R₃₀, R₃₁, R₄₀, R₄₁, R₄₂, Y, R₈₁, R₈₂, R₉₁, R₉₂, R₉₃, R₉₄, R₆₀ and R₆₁ each is a straight, branched or cyclic alkyl group (such as methyl, ethyl, propyl, isopropyl, tert-butyl, cyclohexyl, tert-hexyl, tert-octyl, dodecyl, hexadecyl, octadecyl and benzyl), the alkenyl group defined by R₁₀, R₂₀, R₂₁, R₂₂,R₃₀, R₃₁, R₄₀, R₄₁, R₄₂, Y, R₈₁, R₈₂, R₉₁, R₉₂, R₉₄, R₆₀ and R₆₁ each is a straight, branched or cyclic alkenyl group (such as vinyl, allyl, 2-pentenyl, cyclohexenyl, hexenyl, dodecenyl and octadecenyl), the aryl group defined by R₁₀, R₂₀, R₂₁, R₂₂, R₃₀, R₃₁, R₄₀, R₄₁, R₄₂, Y, R₈₁, R₈₂, R₉₁, R₉₂, R₉₄, R₆₀ and R₆₁ each is a single benzene ring or a fused polycyclic aryl group (such as phenyl, naphthyl and anthranyl) and the heterocyclic group defined by R₄₁, R₄₂. Y, R₆₀, R₈₁, R₈₂, R₉₁, R₉₂, R₉₃, R₉₄ and R₆₁ is a five- to seven-membered cyclic group containing at least one atom selected from nitrogen atom, sulfur atom and oxygen atom as a ring-constituting atom (such as furyl, pyrrolyl, imidazolyl, pyridyl, purinyl, chromanyl, pyrrolidyl and morpholinyl).

R₁₀ is an alkyl group, an alkenyl group or an aryl group. R₂₀, R₂₁ and R₂₂ may be same or different and each is an alkyl group, an alkenyl group, an aryl group, an alkoxy group. (such as methoxy, ethoxy, methoxyethoxy, octyloxy, benzyloxy, cyclohexyloxy, isopropoxy, tetradecyloxy and octadecyloxy), an alkenoxy group (such as vinyloxy, propenyloxy, cyclohexenyloxy, dodecenyloxy and octadecenyloxy), an aryloxy group (such as phenoxy and naphthoxy), an alkylthio group (such as methylthio, ethylthio, isopropylthio, cyclohexylthio, benzylthio, octylthio, dodecylthio, hexadecylthio and octadecylthio), an alkenylthio group (such as vinylthio, allylthio, cyclohexenylthio and hexadecenylthio) and an arylthio group (such as phenylthio and naphthylthio). R₃₀ and R₃₁ may be same or different and each is an alkyl group, an alkenyl group and an aryl group. R₄₀ is an alkyl group. R₄₁, R₄₂ and Y may be same or different and each is hydrogen atom, an alkyl group, an alkenyl group, an aryl group, a heterocyclic group, the same alkoxy group as R₂₀, an alkenoxy group, an aryloxy group, an alkylthio group, an alkenylthio group, an arylthio group, a heterocyclic oxy group (such as imidazolidinyloxy, morpholinyloxy, tetrahydropyran-3-yloxy and 1,3,5-triazin-2-yloxy), hydroxy group, an optionally substituted amino group (such as amino, alkylamino, arylamino, dialkylamino, acylamino, sulfonamide, ureido and urethane), carbamoyl group (such as N-methylcarbamoyl, N-phenylcarbamoyl and N,N-diethylcarbamoyl), sulfamoyl group (such as N-ethylsulfamoyl and N-phenylsulfamoyl), an alkoxycarbonyl group (such as methoxycarbonyl, butoxycarbonyl, cyclohexyloxycarbonyl, octyloxycarbonyl, hexyloxycarbonyl and octadecyloxycarbonyl), an aryloxycarbonyl group (such as phenyoxycarbonyl and naphthyloxycarbonyl), halogen atom (such as acetyl, benzoyl and naphthoyl), halogen atom (such as fluorine atom, chlorine atom and bromine atom), nitro group, cyano group, an acyl group (such as acetyl, benzoyl and naphthoyl) and an acyloxy group (such as acetyloxy, benzoyloxy and naphthoyloxy). m is an integer of 0 to 2. R₆₀ and R₆₁ may be same or different and each is an alkyl group, an alkenyl group, an aryl group and a heterocyclic group. Z is a group defined by Y and n is an integer of 0 to 4. When m is 2, plural Y may be same or different and, similarly, when n is 2 to 4, plural Z may be same or different. R₂₀ and R₂₁ or R₃₀ and R₃₁ may be bonded each other to form a five- to seven-membered ring.

R₁, R₂ and R₃ may be same or different and each is hydrogen atom, an aliphatic group, an aromatic group, a heterocyclic group or amino group. At least two groups in R₁, R₂ and R₃ may be bonded each other forming a five- to eight-membered ring. It is also possible that R₁ and R₂ may form an unsaturated group in a cooperative manner and may form a five- to eight-membered ring together with R₃. However, the case where R₁, R₂ and R₃ are hydrogen at the same time is excluded. Here, the aliphatic group is a straight, branched or cyclic alkyl group (such as methyl, ethyl, propyl, isopropyl, tert-butyl, cyclohexyl, tert-hexyl, tert-octyl, dodecyl, hexadecyl, octadecyl and benzyl), an alkenyl group (such as vinyl, allyl, 2-pentenyl, cyclohexenyl, hexenyl, dodecenyl and octadecenyl) and an alkynyl group (such as propynyl and hexadecynyl) and those groups may be substituted with substituent(s). Here, the aromatic group is a single benzene ring or a condensed and polycyclic aryl group (such as phenyl, naphthyl and anthranyl). Those rings may be substituted. Here, the heterocycle is a five- to seven-membered ring containing at least one atom selected from nitrogen atom, sulfur atom and oxygen atom as a ring-constituting atom (such as furyl, pyrrolyl, imidazolyl, pyridyl, purinyl, chromanyl, pyrrolidyl and morpholinyl). Here, the amino group may be just an amino group or an N-substituted amino group having substituent(s).

Examples of the substituent which may be present in each of the above-mentioned groups are an aliphatic group, an aromatic group, a heterocyclic group, an acyl group, sulfonyl group, sulfamoyl group and carbamoyl group.

It is also possible that at least two groups in R₁, R₂ and R₃ are bonded each other to form a five- to eight-membered ring (such as pyrrolidine ring, imidazoline ring, imidazolidine ring, pyrazolidine ring, piperazine ring, piperidine ring, morpholine ring, indoline ring and quinuclidine ring). It is further possible that R₁ and R₂ may form an unsaturated group in a cooperative manner and may form a five- to eight-membered ring together with R₃ (such as pyridine ring, quinoline ring, pteridine ring and phenanthroline ring).

M₁ is an alkali metal (such as lithium, sodium and potassium) or an alkaline earth metal (such as calcium, barium and magnesium). R₈₁ and R₈₂ each is an alkyl group, an alkenyl group, an aryl group and a heterocyclic group. They may be same or different. Here, the alkyl group is a straight, branched or cyclic alkyl group (such as methyl, ethyl, propyl, isopropyl, tert-butyl, cyclohexyl, tert-hexyl, tert-octyl, dodecyl, hexadecyl, octadecyl and benzyl), the alkenyl group is a straight, branched or cyclic alkenyl group (such as vinyl, allyl, 2-pentenyl, cyclohexenyl, hexenyl, dodecenyl and octadecenyl), the aryl group is a single benzene ring or a fused polycyclic aryl group (such as phenyl, naphthyl and anthranyl) and the heterocyclic group is a five- to seven-membered cyclic group containing at least one atom selected from nitrogen atom, sulfur atom and oxygen atom as a ring-constituting element (such as furyl, pyrrolyl, imidazolyl, pyridyl, purinyl, chromanyl, pyrrolidyl and morpholinyl). M₂ is an alkali metal (such as lithium, sodium and potassium). M₃ is an alkali metal (such as lithium, sodium and potassium) or an alkaline earth metal (such as calcium, barium and magnesium).

R₉₁, R₉₂, R₉₃ and R₉₄ each is an alkyl group, an alkenyl group, an aryl group and a heterocyclic group. They may be same or different. Here, the alkyl group is a straight, branched or cyclic alkyl group (such as methyl, ethyl, propyl, isopropyl, tert-butyl, cyclohexyl, tert-hexyl, tert-octyl, dodecyl, hexadecyl, octadecyl and benzyl), the alkenyl group is a straight, branched or cyclic alkenyl group (such as vinyl, allyl, 2-pentenyl, cyclohexenyl, hexenyl, dodeceny and octadecenyl), the aryl group is a single benzene ring or a fused polycyclic aryl group (such as phenyl, naphthyl and anthranyl) and the heterocyclic group is a five- to seven-membered cyclic group containing at least one atom selected from nitrogen atom, sulfur atom and oxygen atom as a ring-constituting atom (such as furyl, pyrrolyl, imidazolyl, pyridyl, purinyl, chromanyl, pyrrolidyl and morpholinyl).

R₉₁ and R₉₂ or R₉₃ and R₉₄ may be bonded each other to form a five- to eight-membered ring (such as pyrrolidine ring, imidazoline ring, imidazolidine ring, pyrazolidine ring, piperazine ring, piperidine ring, morpholine ring, indoline ring and quinuclidine ring).

In the compounds represented by the formula (A-II), preferred ones are those where all of R₂₀ to R₂₂ are selected from an alkyl group, an aryl group, an alkoxy group and an aryloxy group. Those where all of R₂₀ to R₂₂ are selected from an alkyl group, an aryl group and an aryloxy group are more preferred and, among them where an aryloxy group is available, those where there is a substituent at an ortho-position of a benzene ring of the aryloxy group are preferred. When at least two of R₂₀ to R₂₂ are aryloxy groups, those where each ortho-position of the benzene ring of the two aryloxy groups or substituents at ortho-position is/are bonded are preferred.

Among the compounds represented by the formula (B-I), preferred ones are able to be represented by the following formulae (B-I-I) and (B-I-II).

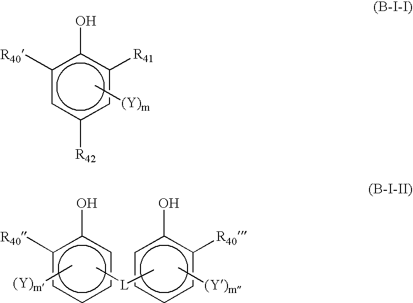

In the formulae, R₄₀′ is a tertiary alkyl group and R₄₀″ and R₄₀′″ may be same or different and each is an alkyl group. L is a single bond or the following connecting groups.

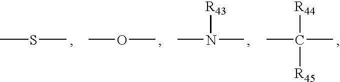

Here, R₄₃ is hydrogen atom, an alkyl group or an aryl group. R₄₄ and R₄₅ may be same or different and each is hydrogen atom, an alkyl group or an aryl group. R₄₁, R₄₂, Y and m have the same meanings as those in the formula (B-I) and Y′ has the same meaning as Y. m′ and m″ have the same meaning as m.

Among the compounds represented by the formula (D-I), preferred one is a compound where pKa is 4 or more, that where pKa is 4 to 9 is more preferred and that where pK is 5 to 8 is still more preferred. Particularly preferred compound is an amine compound where pKa is 5 to 7. Here, pKa is a dissociation constant of a conjugate acid or an amine compound and is a value measured at room temperature in a mixed solvent of EtOH/H₂O=4/1. Generally, this value is able to be determined by a titration method. Further, in this amine compound, a lipophilic compound is preferred and total carbon atom numbers are preferably 8 or more and, more preferably, they are 15 or more.

Still further, in this amine compound, a tertiary amine is preferred. Among the compounds represented by the formula (D-I), the most preferred one is a lipophilic amine compound represented by the following formula (D-I-I) where pKa is 4 to 7.

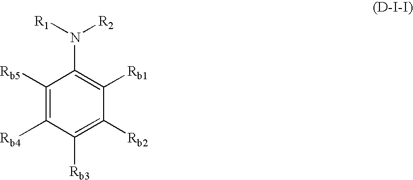

In the formula, R₁ and R₂ are the same as those in the formula (D-I). R_{b1} to R_{b5} may be same or different and each is hydrogen atom, an aliphatic group, an aromatic group, a heterocyclic group, an aliphatic oxy group, an aromatic oxy group, a heterocyclic oxy group, an aliphatic thio group, an aromatic thio group, a heterocyclic thio group, hydroxy group, halogen atom, cyano group, nitro group, an optionally substituted amino group, sulfonyl group, an acyl group, an acyloxy group, sulfamoyl group, carbamoyl group or an ester group. Groups in ortho-positions in R₁ and R₂, R₁ and R_{b5}, R₂ and R_{b1} or R_{b1} to R_{b5} may be bonded to form a five- to eight-membered ring.

With regard to the preferred (D) acid capturing agent of the present invention, the amine compound represented by the above formula (D-VIII) may be also listed in addition to the above-mentioned ones.

In the formula(D-VIII), X₁ is a single bond or a di- to trivalent organic residue and B₁ is an aryl group having an amino group, an aryloxy group or a nitrogen-containing heterocyclic group with a proviso that X₁ is not —O— or —(CH₂)₄—. p is 2 or 3. Examples of X₁ are a single bond, a di- or trivalent residue connected to B₁ by carbon atom, nitrogen atom or phosphorus atom and a divalent connecting group such as —S—, —SO₂—, —O—Ar—O—, —O—Ar—(CR₄R₅)ₙ—Ar—O—, —O—Ar—SO₂—Ar—O— and —O—CH₂—Y₁—CH₂—O—. Here, Ar is an arylene group, R₄ and R₅ each is an alkyl group and Y₁ is CR₄R₅ or —CH₂OCH₂—. B₁ is an aryl group having an amino group where pKa (value measured in a mixed solvent of ethanol/water=4/1) is 4 or more, an aryloxy group or a nitrogen-containing heterocyclic group. The amino group mentioned here may be unsubstituted or substituted. Examples of the substituent for the amino group are an alkyl group, a cycloalkyl group, an aralkyl group, an aryl group and a heterocyclic group. As to an amino group, a tertiary amino group is particularly preferred and a cyclic tertiary amino group is also used preferably. Examples of the nitrogen-containing heterocyclic group are pyrrolidino group, piperidino group, morpholine group, piperazino group, pyridyl group, pyrimidyl group, quinolyl group, imidazolyl group, pyrrolyl group, indolino group, tetrahydroquinolyl group, imidazolinyl group, thiazolinyl group, imidazolidinyl group and thiazolidiknyl group. The above-mentioned amino group and nitrogen-containing heterocyclic group may further contain other substituent.

In the amine compound represented by the formula (D-VIII) of the present invention, more preferred one is that of a molecular weight of 300 or more having substantially no volatility.

In the amine compound represented by the formula (D-VIII) of the present invention, the most preferred one is that having substantially no volatility where molecular weight per basic group is 200 or less.

In the compound represented by the formula (B-I), more preferred one is that where pKa is 4 to 9, still more preferred one is that where pK is 5 to 8 and the most preferred one is that where pKa is 5 to 7.

Specific examples of the compound represented by the formulae (A-I) to (D-VIII) of the present invention are the compounds mentioned in [0063] to [0064] of the specification of Japanese Patent Laid-Open No. 05/197,073.

Nearly all of those compounds have been put on the market already and, therefore, they are easily available. Other preferred examples of the amine compound represented by the formulae (D-I) and (D-VIII) and synthetic methods thereof are mentioned in U.S. Pat. Nos. 4,483,918, 4,555,479, 4,585,728 and 4,639,415, European Patent Laid-Open No. 264,730 and Japanese Patent Laid-Open Nos. 58/102,231, 59/229,557, 61/073,152, 63/098,662, 63/115,167 and 63/267,944, etc.

Now, a cellulose acylate film where amount of an organic chlorine-type solvent is made 10 ppm or less will be illustrated.

In order to make the amount of the organic chlorine-type solvent (usually, it is mostly methylene chloride) contained in the film immediately after manufacture 10 ppm or less, that is achieved by a cellulose acylate layered film which is characterized in that the film has a core part comprising a cellulose acylate having a degree of substitution of 2.7 or less and has a surface layer comprising a cellulose acylate where degree of substitution is 2.8 or more having a thickness of 0.5 μm to 15 μm on at least one side of the said core part. In order to make the amount of the organic chlorine-type solvent in the above film 10 ppm or less, that is achieved by the manufacture of a cellulose acylate layered film in such a manner that a surface layer comprising cellulose acylate having a film thickness of 0.5 μm to 15 μm where degree of substitution is 2.8 or more is subjected to a solution filming by a dope prepared by a solvent containing 70% or more methylene chloride or N-methyl-2-pyrrolidone and a core part comprising a cellulose acylate of degree of substitution of 2.7 or less is subjected to a solution filming by a dope prepared from a solvent containing 60% or more acetone whereby a cellulose acylate layered film is manufactured.

In a cellulose acylate layered film of the present invention, when a film having a layered structure comprising a surface layer having cellulose acylate where degree of substitution is 2.8 or more and a core part having a cellulose acylate where degree of substitution is 2.7 or less, it is now possible to significantly reduce the amount of the contained solvent and also to give a cellulose acylate film having an excellent resistance to a humid heat. Film which is prepared from a cellulose acylate where degree of substitution is 2.8 or more (hereinafter, it may be referred to as TAC in the case of a cellulose acetate) has an excellent characteristic that moisture permeability is significantly little as compared with film of a cellulose acylate where degree of substitution is 2.7 or less (hereinafter, it may be referred to as DAC in the case of a cellulose acetate). Illustration will be made taking a cellulose acetate as an example. Thus, when a cellulose acylate or TAC where degree of substitution is 2.8 or more having little humidity permeation is formed on the surface layer of a cellulose acylate or DAC where degree of substitution is 2.7 or less, invasion of moisture from outer environment is able to be prevented by TAC whereupon DAC which is insufficient in resistance to humid heat is able to be protected. As a result, the film as a whole becomes good in resistance to humidity and heat with a lapse of time. Degree of substitution of a cellulose acylate or TAC where degree of substitution is 2.8 or more is preferably 2.8 to 3.0 and, more preferably, 2.9 to 3.0. Degree of substitution of a cellulose acylate or DAC where degree of substitution is 2.7 or less is preferably 2.0 to 2.7 and, more preferably, 2.5 to 2.7.

In the present invention, the above-mentioned cellulose acylate film having the layered structure contains a film of a three-layered structure having a surface layer of TAC on both sides of the core part of the DAC in addition to a film of a two-layered structure comprising a surface layer where one layer is TAC and a layer adjacent thereto comprising DAC. Further, the film covers a film comprising three or more layers. In a film having a three-layered structure according to the present invention, thickness of the upper and the lower layers may not be same although the same thickness is preferred due to the reason that, for example, mechanical properties of the film are able to be well balanced. When a functional layer such as a polarized light layer or photosensitive layer is formed on the film surface of DAC which is a core part in the film of the present invention, prevention of moisture can be well achieved by a film of a two-layered structure. A problem in the film of a two-layered structure is able to be solved when, for example, the film is rolled, packed in a moisture-proof manner and preserved. In the present invention, it is preferred to prepare a structure comprising three or more layers where a surface layer of TAC is formed on both sides of the above core part of the DAC. As a result, invasion of moisture into film is able to be prevented in any preservation state and excellent transparency, dimensional stability and resistance to humid heat are able to be maintained for a long period. That which was illustrated for cellulose acetate is also able to be applied to other cellulose acylates.

The surface layer having TAC is a layer of as thin as 0.5 to 15 μm and, therefore, even if it is in a three-layered structure, amount of organic solvent used therefor can be significantly reduced whereby, in view of working environment, that is safe in terms of affection to environment and, in addition, a problem such as the generated haze caused by residual solvent is also able to be improved. Here, film thickness of the above layer having TAC is preferably 0.5 to 10 μm and, more preferably, 1.0 to 5.0 μm.

When a chlorine-type organic solvent is used in preparing a film of TAC in the present invention, it is possible to make the amount of the chlorine-type organic solvent contained in the film immediately after the manufacture 10 ppm or less under the similar condition to a drying condition for the manufacture of the conventional cellulose triacetate film. Amount of the chlorine-type organic solvent is preferably 5 ppm or less. As a result, in view of working environment, that is safer in terms of affection to environment and, in addition, problem such as the generated haze caused by residual solvent is also able to be significantly improved. In the present invention, even when a film is made into a three-layered structure where both upper and lower layers are films made from a cellulose acylate dissolved in methylene chloride, amount of the organic chlorine-type solvent (usually, it is mostly methylene chloride) contained in the film immediately after manufacture is able to be made 10 ppm or less. Providing of a cellulose acylate film where the amount of the organic chlorine-type solvent is 10 ppm or less is practically impossible in case the film of 50 μm or more is prepared from a dope of a solution having methylene chloride because manufacture of a film of 10 ppm or less is not possible unless a drying is conducted for a significantly long period.

Melting point of N-methyl-2-pyrrolidone (NMP) is higher than that of methylene chloride and amount of the residual solvent becomes significantly high. In the present invention, film thickness of the layer having TAC is so thin that it is 15 μm in maximum and, therefore, even when it is made into a film of three-layered structure where upper and lower surface layers are formed, amount of the residual NMP immediately after the manufacture is able to be made 2,000 pm or less. Amount of the residual NMP is preferably 1,500 ppm or less. As a result, a drying load for drying the surface layer is not big and that does not cause a problem in the manufacture. In addition, amount of the residual solvent is little and, in the formation of film, use of a chlorine-type solvent is not necessary whereby there is no problem for residue of chlorine-type solvent as well. Further, haze which is generated by a large amount of residual NMP is able to be prevented and transparency of the film during preservation is able to be maintained.

A cellulose acylate film manufactured by a non-chlorine-type solvent and a process for producing the same are mentioned in detail in Kokai Giho (Journal of Technical Disclosure), No. 2001/1745 published by JIII (the Japan Institute of Invention and Innovation).

Now illustration will be made for a cellulose acylate film containing a polyhydric alcohol ester of an aliphatic polyhydric alcohol with one or more monocarboxylic acid(s). The aliphatic polyhydric alcohol ester according to the present invention is an ester of an aliphatic polyhydric alcohol having two or more hydroxyl groups with one or more member(s) of monocarboxylic acid.

The aliphatic polyhydric alcohol used in the present invention is a di- or higher hydric alcohol and is represented by the following formula (a).

Formula (a): R₁₁—(OH)ₙ

In the formula, R₁₁ is an n-valent aliphatic organic group, n is a positive integer of 2 or more and OH group is at least any of an alcoholic hydroxyl group and a phenolic hydroxyl group.

Examples of the n-valent aliphatic organic group are an alkylene group (such as methylene group, ethylene group, trimethylene group and tetramethylene group), an alkenylene group (such as ethenylene group), an alkynylene group (such as ethynylene group), a cycloalkylene group (such as 1,4-cyclohexanediyl group) and an alkanetriyl group (such as 1,2,3-propanetriyl group). The n-valent aliphatic organic group includes that which has a substituent (such as hydroxyl group, an alkyl group and halogen atom). n is preferably 2 to 20.

Examples of the preferred n-valent polyhydric alcohol are adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol. Particularly preferred ones are triethylene glycol, tetraethylene glycol, dipropylene glycol, tripropylene glycol, sorbitol, trimethylolpropane and xylitol.

With regard to a monocarboxylic acid in the polyhydric alcohol ester of the present invention, there is no particular limitation and known aliphatic monocarboxylic acid, alicyclic monocarboxylic acid, aromatic monocarboxylic acid, etc. may be used. The use of alicyclic monocarboxylic acid and aromatic monocarboxylic acid is preferred in view of improvement of resistance to permeation of moisture of cellulose acylate film.

Examples of the preferred monocarboxylic acid are as follows although the present invention is not limited thereto.

With regard to the aliphatic monocarboxylic acid, a straight or branched fatty acid having 1 to 32 carbon(s) may be preferably used. Carbon number(s) is/are more preferably 1 to 20 and, particularly preferably, 1 to 10. When acetic acid is contained therein, miscibility with a cellulose ester increases whereby that is preferred and it is also preferred that acetic acid is mixed with other monocarboxylic acid.

Examples of the preferred aliphatic monocarboxylic acid are a saturated fatty acid such as acetic acid, propionic acid, butyric acid, valeric acid, caproic acid, enanthic acid, caprylic acid, pelargonic acid, capric acid, 2-ethylhexanecarboxylic acid, undecylenic acid, lauric acid, tridecylic acid, myristic acid, pentadecylic acid, palmitic acid, heptadecylic acid, stearic acid, nonodecanoic acid, arachic acid, behenic acid, lignoceric acid, cerotic acid, heptacosanoic acid, montanic acid, melissic acid and lacceric acid; an unsaturated fatty acid such as undecylenic acid, oleic acid, sorbic acid, linoleic acid, linolenic acid and arachidonic acid; etc. They may be further substituted.

Examples of the preferred alicyclic monocarboxylic acid are cyclopentanecarboxylic acid, cyclohexanecarboxylic acid, cyclooctanecarboxylic acid and derivatives thereof

Examples of the preferred aromatic monocarboxylic acid are benzoic acid; that where an alkyl group is introduced into a benzene ring of benzoic acid such as toluic acid; aromatic monocarboxylic acid having two or more benzene rings such as biphenylcarboxylic acid, naphthalenecarboxylic acid and tetralincarboxylic acid; and derivatives thereof. Benzoic acid is particularly preferred.

Although there is no particular limitation for the molecular weight of the polyhydric alcohol used in the present invention, it is preferred to be 300 to 1,500 and, more preferably, it is 350 to 750.

Carboxylic acid in the polyhydric alcohol ester of the present invention may be one kind or a mixture of two or more kinds. With regard to OH groups in the polyhydric alcohol, all of them may be esterified or a part of them may be left unesterified as OH. It is preferred that three or more aromatic rings or cycloalkyl rings are present in a molecule.

Specific examples of the polyhydric alcohol used in the present invention are as follows although the present invention is not limited thereto.

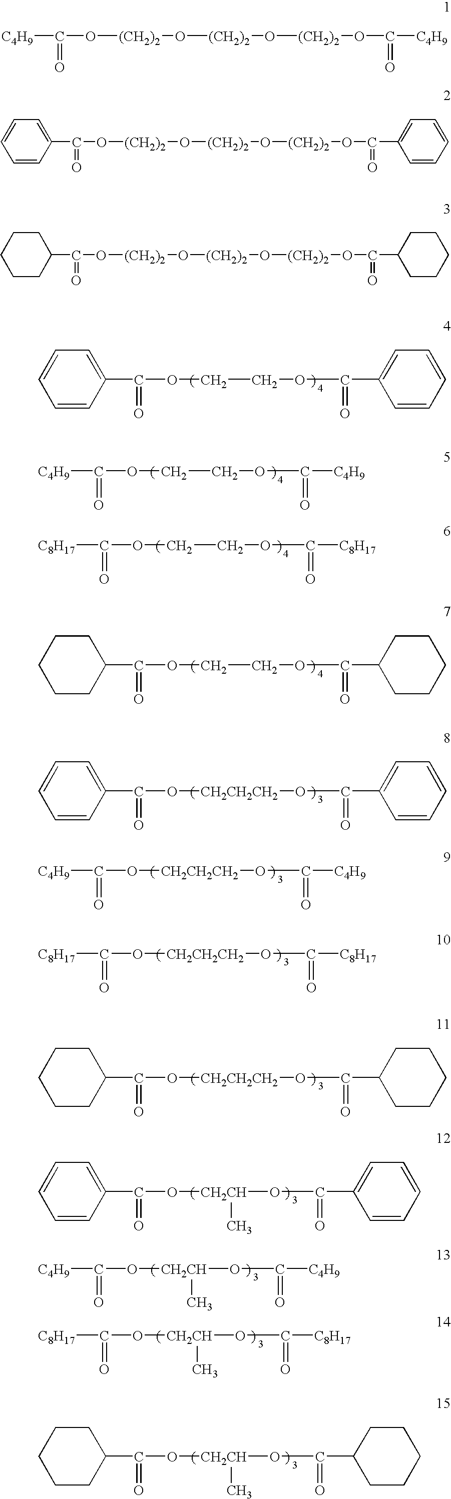

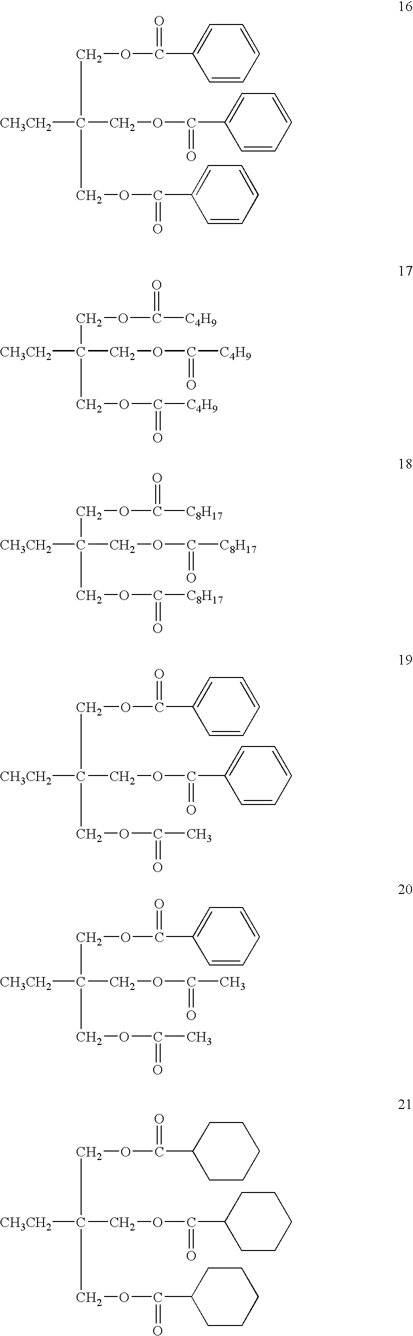

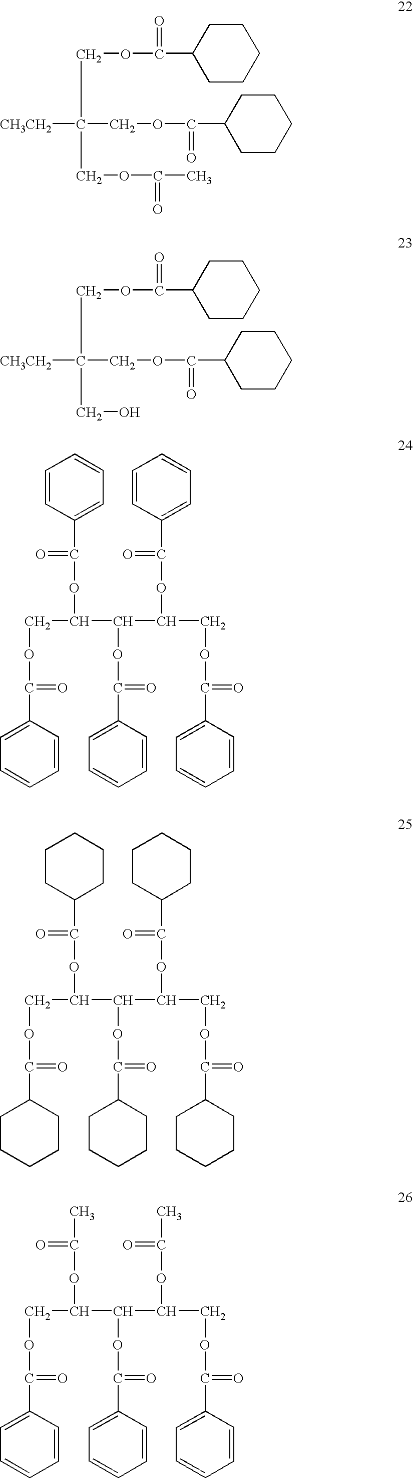

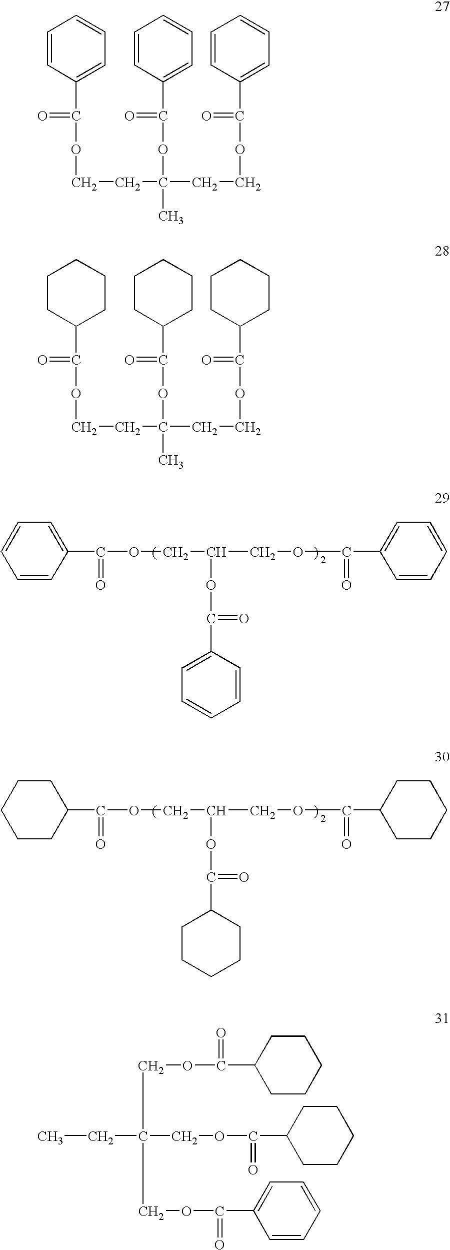

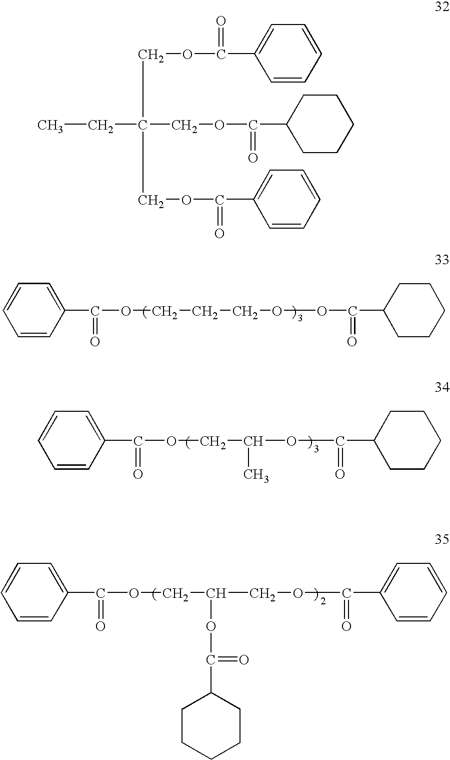

Amount of the polyhydric alcohol ester used to a cellulose acylate is preferably 3 to 30% by weight, more preferably 5 to 25% by weight and, particularly preferably, 5 to 20% by weight.

Such a polyhydric alcohol ester is able to be preferably used as a substitute for a phosphate which has been used by mixing in a cellulose acylate such as triphenyl phosphate. Thus, it is preferred that amount of the phosphate in a cellulose acylate film is reduced to 0.1 g/m² or less or that only a polyhydric alcohol ester without using a phosphate is used for a cellulose acylate film.

Hard Coat Layer

In order to prevent scratch of recording layer and light transmitting layer, the light transmitting layer of the present invention may form a hard coat layer thereon. In that case, it is preferred that the hard coat layer has such a resistance against scratching that, when its surface is abraded for 50 times coating a load of 1.96 N/cm² using a steel wool of #0000, the scar is unable to be detected by naked eye.

The above-mentioned resistance against scratch evaluated by abrasion with a steel wool is a property of prevention of scratch to the force applied in the direction near horizon to the surface of the surface and it is desired that the resistance is also strong against the force applied in a vertical direction to the surface. Scratch generated by the force applied vertically to the surface is able to be evaluated by means of pencil hardness.

Pencil hardness is able to be measured as hardness where no stab is noted by a load of 9.8 N using a pencil for the test regulated by JIS-S-6006 in accordance with a method of pencil hardness evaluation regulated by JIS-K-5400.

The demanded pencil hardness is preferably H or higher or, more preferably, 2H or higher.

When the hard coat layer is too thick, curl is apt to take place while, when it is too thin, a hard coat function is rarely achieved. Therefore, film thickness is preferably 1.0 to 10.0 μm, more preferably 2.0 to 6.0 μm and, particularly preferably, 2.5 to 5.0 μm.

A preferred method for the formation of the hard coat layer according to the present invention is a method where an ultraviolet-setting composition which is hardened by irradiation of active energy light or, preferably, ultraviolet ray is applied on a transparent plastic substrate film, dried and irradiated with ultraviolet ray so that the said composition is hardened.

With regard to the ultraviolet-setting composition, a compound having two or more ethylenic unsaturated bonds in the same molecule which is hardened by polymerization of cross-linking being irradiated with ultraviolet ray is preferably used.

As hereunder, illustration will be made for an ultraviolet-setting composition being preferably used in the present invention which has a compound containing two or more ethylenic unsaturated groups in the same molecule.

Preferred examples of the above ethylenic unsaturated group are acryloyl group, methacryloyl group, styryl group and vinyl ether group and particularly preferred one is acryloyl group. The compound having ethylenic unsaturated group may have two or more ethylenic unsaturated groups in a molecule and, more preferably, three or more. Among them, a compound having acryloyl groups is preferred and preferably used ones are a compound which is called a multifunctional acrylate monomer having 2 to 6 acrylate groups in a molecule and an oligomer which is called urethane acrylate, polyester acrylate or epoxy acrylate having several acrylate groups in a molecule and molecular weight of several hundred to several thousand.

Preferred specific examples of the compound as such having two or more ethylenic unsaturated bonds are polyol polyacrylate such as divinylbenzene, ethylene glycol diacrylate, trimethylolpropane triacrylate, ditrimethylolpropane tetraacrylate, pentaerythritol triacrylate, pentaerythritol tetraacrylate, dipentaerythritol pentaacrylate and dipentaerythritol hexaacrylate; diacrylate such as bisphenol A diglycidyl ether; epoxy acrylate such as hexanediol diglycidyl ether diacrylate; urethane acrylate prepared by the reaction of polyisocyanate with hydroxyl-containing acrylate (e.g. hydroxyethyl acrylate); etc.

Those compounds are also available in the market and examples thereof are EB-600, EB-40, EB-140, EB-1150, EB-1290K, IRR 214, EB-2220, TMPTA and TMPTMA (all manufactured by Daicel UCP), UV-6300 and UV-1700B (manufactured by Nippon Synthetic Chemical Industry), etc.

Among the above-mentioned compounds having two or more ethylenic unsaturated groups in a molecule, the particularly preferred one is a compound having three or more acryloyl group in a molecule where an acryloyl equivalent is 120 or less and its specific examples are trimethylolpropane triacrylate, ditrimethylolpropane tetraacrylate, pentaerythritol triacrylate, pentaerythritol tetraacrylate, dipentaerythritol pentaacrylate and dipentaerythritol hexaacrylate.

With regard to a compound which is preferably used for the ultraviolet-setting composition of the present invention besides the above-mentioned compound having two or more ethylenic unsaturated groups in a molecule, a setting resin having a ring-opening polymerizable group may be listed.

A setting resin having a ring-opening polymerizable group is a setting resin having a ring structure where ring opening reaction proceeds by action of cation, anion, radical, etc. and, among that, a setting resin containing a heterocyclic group is preferred. Examples of such a setting resin are compound containing epoxy group, compound containing oxetanyl group, compound containing tetrahydrofuranyl group, cyclic lactone compound, cyclic carbonate compound, compound containing oxazolinyl group and other cyclic imino ether. Particularly preferred ones are compound containing epoxy group, compound containing oxetanyl group and compound containing oxazolinyl group. In the present invention, it is preferred that a setting resin having ring-opening polymerizable group has two or more ring-opening polymerizable groups in a molecule and it is more preferred to have three or more thereof In the present invention, two or more kinds of the setting resin having ring-opening polymerizable groups may be used together and, in that case, a setting resin having one ring-opening polymerizable group in a molecule may be used together if necessary.

There is no particular limitation for the setting resin having ring-opening polymerizable group used in the present invention so far as it is a setting resin having the above-mentioned ring structure. Preferred examples of such a setting resin are monofunctional glycidyl ether, monofunctional alicyclic epoxide, bifunctional alicyclic epoxide, diglycidyl ether (such as ethylene glycol diglycidyl ether, bisphenol A diglycidyl ether and trimethylolethane triglycidyl ether as the glycidyl ether), three- or more functional glycidyl ether (such as trimethylolethane triglycidyl ether, trimethylolpropane triglycidyl ether, glycerol triglycidyl ether and triglycidyl trishyydroxyethyl isocyanurate), four or more functional glycidyl ether (such as sorbitol tetraglycidyl ether, pentaerythritol tetraglycidyl ether, polyglycidyl ether of cresol novolak resin and polyglycidyl ether of phenol novolak ether), acrylic polymer having epoxy group in side chain such as polyglycidyl acrylate and polyglycidyl methacrylate, alicyclic epoxide (such as Celloxide 2021P, Celloxide 2081, Epolead GT-301 and Epolead GT-401 (all manufactured by Daicel Chemical Industry), EHPE (manufactured by Daicel Chemical Industry), polycyclohexyl epoxymethyl ether of phenol novolak resin, etc.), oxetane (such as OX-SQ and PNOX-1009 (all manufactured by Toa Gosei), etc. although the present invention is not limited thereto.

In the present invention, it is also possible to use a setting resin containing both of a setting compound containing ethylenic unsaturated group and a setting resin containing a ring-opening polymerizable group.

When a setting composition (hereinafter, “setting composition” means a composition which contains the following both setting resins unless otherwise mentioned) which contains a setting compound containing ethylenic unsaturated group (setting resin) and a setting resin containing a ring-opening polymerizable group is hardened, it is preferred that a cross-linking reaction of both setting resins proceeds. A preferred cross-linking reaction for the ethylenic unsaturated group is a radical polymerization reaction while a preferred cross-linking reaction is a cation polymerization reaction. In any of the cases, polymerization reaction is able to be proceeded by action of active energy ray. Usually, a small amount of radical generator and cation generator (or acid generator) which are called polymerization initiator are added, those are decomposed by active energy ray so that radical and cation are generated whereby polymerization is able to be proceeded. Although radical polymerization and cation polymerization may be carried out separately, it is preferred to make them proceeded at the same time.

Examples of a photooxygen generator where cation is generated by ultraviolet ray are an ionic setting resin such as triarylsulfonium salt and iodonium salt and a nonionic setting resin such as nitrobenzyl ester of sulfonic acid and various known photooxygen generators such as setting resins mentioned, for example, in “Organic Materials for Imaging”, edited by Organic Electronics Material Study Group, published by Bunshin Shuppansha (1997) may be used. Among them, particularly preferred one due to little coloration to yellow is a diaryl iodonium salt while, with regard to a counter-ion, preferred ones are PF₆⁻, SbF₆⁻, AsF₆⁻, B(C₆H₅)₄⁻, etc. It is also a preferred embodiment that a triaryl sulfonium salt and a diaryl iodonium salt are used together.

Examples of a polymerization initiator where radical is generated by ultraviolet ray are acetophenones, benzophenones, Michler's ketone, benzoyl benzoate, benzoins, α-acyloxim ester, tetramethylthiuram monosulfide and thioxanthone and the known radical generators as such are able to be used. Examples of a sensitizer are n-butylamine, triethylamine, tri-n-butylphosphine and thioxanthone compounds.

With regard to amount of the polymerization initiator, it is preferred to be within a range of 0.1 to 15% by weight or, more preferably, within a range of 1 to 10% by weight to the total weight of a setting resin containing ethylenic unsaturated group and a setting resin containing ring-opening polymerizable group contained in a setting composition.

In the present invention, it is also preferred to add fine particles to a setting composition. When inorganic fine particles are added, it is possible to suppress swelling by a solvent of a transparent plastic substrate film. It is further possible to reduce a shrinking amount of hardened film upon hardening by addition of fine particles and, therefore, that is preferred in view of improvement in close adhesion to a substrate film and of reduction of curl as well. With regard to the fine particles, any of inorganic fine particles, organic fine particles and compounded organic/inorganic fine particles may be used. However, fine particles usually tend to increase haze and, therefore, it is necessary to adjust a method for charging them taking a balance of necessary characteristics into consideration.

Examples of inorganic fine particles are silicon dioxide particle, titanium dioxide particles, zirconium oxide particles and aluminum oxide particles. Such inorganic cross-linking fine particles are usually hard and, when they are charged in a hard coat layer, not only shrinking upon hardening is improved but also hardness of the surface is able to be enhanced. Average particle size of the inorganic particles is preferred to be 5 to 200 nm.

In general, inorganic fine particles have low affinity to organic components such as the above-mentioned setting resin which is able to be used in the present invention. Therefore, when they are just mixed, there are some cases where aggregates are formed or a hardened film after hardening is apt to be cracked. In order to promote the affinity between inorganic fine particles and organic component, it is possible in the present invention to treat the inorganic fine particle surface with a surface modifier containing organic segments. With regard to the surface modifier, it is preferred to have a functional group which forms a bond with inorganic fine .particles or is able to be adsorbed with inorganic fine particles and a functional group having a high affinity to organic component in the same molecule.

Preferred surface modifier having a functional group which is able to bond to or to be adsorbed with inorganic fine particles are a metal alkoxide surface modifier such as silane, aluminum, titanium and zirconium and a surface modifier having anionic group such as phosphoric acid group, sulfuric acid group, sulfonic acid group and carboxylic acid group.

With regard to a functional group having high affinity to organic component, although that which has just the same hydrophilicity/hydrophobicity to the organic component may be used, a functional group which is able to bond to the organic component is preferred and particularly preferred ones are ethylenic unsaturated group and ring-opening polymerizable group.

Preferred inorganic fine particle surface modifier in the present invention is a setting resin having metal alkoxide or anionic group and ethylenic unsaturated group or anionic group and ring-opening polymerizable group in the same molecule.

Representative examples of such a surface modifier are the following coupling agent containing unsaturated double bond, organic setting resin containing phosphoric acid, organic setting resin containing sulfuric acid group and organic setting resin containing carboxylic acid group.

S-1: H₂C═C(X)COOC₃H₆Si(OCH₃)₃

S-2: H₂C═C(X)COOC₂H₄OTi(OC₂H₅)₃

S-3: H₂C═C(X)COOC₂H₄OCOC₅H₁₀OPO(OH)₂

S-4: (H₂C═C(X)COOC₂H₄OCOC₅H₁₀O)₂POOH

S-5: H₂C═C(X)COOC₂H₄OSO₃H

S-6: H₂C═C(X)COO(C₅H₁₀COO)₂H

S-7: H2C═C(X)COOC₅H₁₀COOH

S-8: 3-(glycidyloxy)propyltrimethylsilane

(X═H or CH₃)

It is preferred that surface modification by such inorganic fine particles is conducted in a solution. In a mechanical fine dispersing of the inorganic fine particles, a surface modifier may be existed at the same time; after inorganic fine particles are finely dispersed, a surface modifier may be added thereto and stirred; or, before the inorganic fine particles are finely dispersed, a surface modification is conducted (if necessary, warming, heating after drying or changing the pH may be conducted) and then fine dispersing may be conducted.

With regard to a solvent for dissolving the surface modifier, an organic solvent having a high polarity is preferred. Specific examples are known solvents such as alcohol, ketone and ester.

Although there is no particular limitation for the organic fine particles, preferably used ones are polymer particles comprising monomer having ethylenic unsaturated group such as methyl polymethacrylate, ethyl polymethacrylate, ethyl polyacrylate, butyl polyacrylate, polyethylene, polypropylene and polystyrene and, besides those, resin particles such as polysiloxane, melamine resin, benzoguanamine resin, polytetrafluoroethylene, polycarbonate, Nylon, polyvinyl alcohol, polytetrafluoroethylene, polyethylene terephthalate, polyvinyl chloride, acetylcellulose, nitrocellulose and gelatin may be exemplified. It is preferred that those particles are cross-linked.

With regard to a machine for fine dispersing of fine particles, it is preferred to use ultrasonic wave, disper, homogenizer, dissolver, Polytron, paint shaker, sand grinder, kneader, Aiger mill, Dyno mill and Cobol mill. With regard to a dispersing medium, the above-mentioned solvent for surface modifiers may be preferably used.

Charging amount of fine particles to the volume of hardened film after charging is preferably 2 to 40% by volume, more preferably 3 to 30% by volume and, most preferably, 5 to 20% by volume.

When a hard coat film is used for an optical use, it is preferred that haze is low. Haze of the hardened film of the present invention is 5% or lower, preferably 2% or lower and, most preferably, 1.0% or lower.

In the present invention, an anti-pollution agent is contained in the hardened film prepared as such or an anti-pollutive layer containing at least any of fluorine atom and silicon atom, containing a hardened resin of a low surface energy and mainly comprising a hardened product of setting composition which hardens by irradiation of active energy ray is layered thereon whereupon an anti-pollutive hardened film is prepared.

An anti-pollution agent used in the present invention is to endow an anti-pollutive property such as water repellency and oil repellency to a composition for formation of a substrate film having a setting property and anything may be used so far as it is not inconvenient for preparation of resin composition hardened by energy ray and for coating on a substrate and also it achieves water repellency and oil repellency on the surface of hardened film. An example thereof is a setting resin containing at least any of fluorine atom and silicon atom. It is also possible that an anti-pollution layer which is layered on a hardened film used for the present invention is able to be formed by a composition containing a setting resin containing at least any of fluorine atom and silicon atom.

With regard to a setting resin containing at least any of fluorine atom and silicon atom contained in a hardened film or an anti-pollution layer used in the present invention, its examples are known fluorine setting resin and silicon setting resin or a setting resin having blocks containing a fluorine- and silicon-containing areas. Further, a setting resin containing a segment having a good miscibility to resin, metal oxide or the like and a segment containing fluorine or silicon is preferred and, when it is added to a hardened film or an anti-pollution layer, fluorine or silicon is able to be unevenly distributed on the surface.

Specific examples of such a setting resin are a graft copolymer and a block copolymer of a monomer containing fluorine or silicon with another hydrophilic or lipophilic monomer. Examples of the fluorine-containing monomer are perfluoroalkyl-containing (meth)acrylates such as hexafluoroisopropyl acrylate, heptadecafluorodecyl acrylate, perfluoroalkylsulfonamidoethyl acrylate and perfluoroalkylamidoethyl acrylate. An example of the silicon-containing monomer is a monomer containing siloxane group by the reaction or polydimethylsiloxane with (meth)acrylic acid, etc. In the present specification, description reading “(meth)acrylic acid” means “at least any of acrylic acid and methacrylic acid”. “(Meth)acrylate”, etc. have the same meaning as well.

Examples of the hydrophilic or lipophilic monomer are (meth)acrylate such as methyl acrylate, an ester of (meth)acrylic acid with polyester containing hydroxyl group at its terminal, hydroxyethyl (meth)acrylate and polyethylene glycol (meth)acrylate. Examples of a commercially available setting resin are an acrylate oligomer having a microdomain structure of a perfluoroalkyl chain such as Defensor MCF-300, 312, 323, etc.; an oligomer containing perfluoroalkyl group and lipophilic group such as Megafac F-170, F-173, F-175, etc.; an oligomer containing perfluoroalkyl group and hydrophilic group such as Megafac F-171, etc. (manufactured by Dainippon Ink), a block polymer of a vinyl monomer comprising a segment having an excellent surface transition property and a segment having miscibility to resin such as Modiper F-200, 220, 600, 820, etc. which is a fluorinated alkyl type and Modiper FS-700, 710, etc. which are a silicon type (manufactured by NOF).

In order to form an anti-pollutive layer on a hardened film, a setting resin having a property of a low surface energy containing any of fluorine atom and silicon atom is preferred as mentioned already and specific examples thereof are a silicon setting resin containing fluorinated hydrocarbon group, a polymer containing fluorinated hydrocarbon, etc. mentioned, for example, in Japanese Patent Laid-Open Nos. 57/034,526, 02/019,801 and 03/179,010.

A coating solution of a setting composition is prepared by dissolving the above-mentioned multifunctional monomer and polymerization initiator as main ingredient into an organic solvent for dilution such as ketone, alcohol or ester. It is also possible to prepare by addition of a dispersion of surface-modified hard inorganic fine particles and a dispersion of soft fine particles.

It is preferred that a light transmitting layer of the present invention is adhered via an adhesive layer and a substrate containing a support and a recording layer. In a step where an adhesive layer is installed, an adhesive layer is able to be continuously adhered on a side, which is different from that to which a hard coat layer is applied, of a light transmitting film where a hard coat layer is already formed on one side. A means for installing an adhesive layer may be roughly classified into two—a method where an already-formed adhesive layer is adhered (hereinafter, it may be referred to as an indirect method) and a method where an adhesive is directly applied on the surface of a light transmitting film followed by drying whereupon an adhesive layer is formed (hereinafter, it may be referred to as a direct method).

“A method where an already-formed adhesive layer is adhered” in a direct method is a method where, for example, an adhesive is continuously applied on the surface of a releasing film having the same size as a light transmitting film followed by drying whereupon an adhesive layer is installed on whole area of one side of a releasing film and the adhesive layer is adhered to a light transmitting layer. As a result, an adhesive layer equipped with a releasing film is installed on whole area of another side of the light transmitting film.

A direct method is a method where a front end of a light transmitting film which is wound in a rolled shape is sent out to a predetermined applied region, an adhesive is continuously applied from the front end to another end of one side of the light transmitting film to form a coat and the coat is successively dried so that an adhesive layer is formed on the whole area of another side of the light transmitting film.

In the above-mentioned indirect and direct methods, known coating means may be used as a means for application of the adhesive. Specific examples thereof are a spray method, a roll coat method, a blade coat method, a doctor roll method and a screening printing method.

Although an adhesive of acrylate type, rubber type and silicon type may be used as an adhesive, a hinder of an acrylate type is preferred in view of transparency and durability. With regard to an adhesive of an acrylate type as such, it is preferred to use an adhesive mainly comprising 2-ethylhexyl acrylate, n-butyl acrylate or the like and also containing, for enhancing a cohesive force, a copolymerized product of a short-chain alkyl acrylate or methacrylate such as methyl acrylate, ethyl acrylate or methyl methacrylate with a substance which may act as a cross-linking point with a cross-linking agent such as acrylic acid, methacrylic acid, acrylamide derivative, maleic acid, hydroxyethyl acrylate or glycidyl acrylate. When a mixing ratio of the main ingredient to the short-chain component and the component for adding a cross-linking point and types thereof are appropriately adjusted, it is possible to change a glass transition temperature (Tg) and cross-linking density.

Examples of the cross-linking agent to be used together with the above adhesive are a cross-linking agent of isocyanate type, a cross-linking agent of epoxy resin type, a cross-linking agent of melamine resin type, a cross-linking agent of urea resin type and a cross-linking agent of chelate type and, among them, a cross-linking agent of isocyanate type is more preferred. With regard to the cross-linking agent of isocyanate type as such, isocyanates such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane triisocyanate, a product of such an isocyanate with polyalcohol or a polyisocyanate produced by condensation of isocyanates may be used. Examples of the commercially available product for the isocyanates as such are Coronate L, Coronate HL, Coronate 2030, Coronate 2031, Millionate MR and Millionate HTL manufactured by Nippon Urethane; Takenate D-102, Takenate D-110N, Takenate D-200 and Takenate D-202 manufactured by Takeda Chemical; Desmodur L, Desmodur IL, Desmodur N and Desmodur HL manufactured by Sumitomo-Bayer; etc.

An adhesive layer is formed on a side of a light transmitting film which is other than the side to which a hard coat layer is installed and, in order to prevent that it is wound in a roll shape and the hard coat layer and the adhesive layer are closely adhered in the steps thereafter, it is preferred that a releasing film is adhered on the surface of the adhesive layer. As mentioned above, it is possible to give a state where a releasing film is adhered by an indirect method. On the other hand in the case of a direct method, it is preferred that, after an adhesive layer is formed on the surface of a light transmitting film, a step where a releasing film is adhered on the surface of the adhesive layer is newly added.

Here, examples of the releasing film which is adhered to the surface of an adhesive layer are polyethylene film, polyethylene terephthalate film, polyethylene naphthalate film, polycarbonate film and triacetate cellulose film.

It is preferred that thickness of the information recording carrier of the present invention is thinner than the thickness of the support. When aberration which increases upon inclination of an information recording carrier is taken into consideration, the thickness is preferably 50 to 300 μm, desirably 60 to 200 μm and, more desirably, 70 to 120 μm. Unevenness on a desired side is made ±3 μm at the largest and, preferably, it is to be ±2μ or less. More desirably, it is to be made ±1 μm or less.

In view of water repellency, surface of the light transmitting layer of the present invention is preferably prepared in such a manner that its angle of contact to water is 90° or more.

In the optical information recording carrier according to the present invention, recording and reproduction of information are carried out, for example, as follows. Firstly, light for recording such as bluish violet laser (such as having wavelength of 405 nm) is irradiated via an objective lens from the side of a light transmitting layer together with rotation of the optical information recording carrier in a predetermined linear velocity (0.5 to 10 m/sec) or a predetermined constant angular velocity. Due to the irradiated light as such, the recording layer absorbs the light, temperature rises locally and pit is formed for example and the optical characteristic is changed whereupon information is recorded. Reproduction of the information recorded as mentioned above is able to be carried out in such a manner that laser beam is irradiated from the side of the light transmitting layer using a bluish violet laser as an optical means together with rotation of the optical information recording carrier at a predetermined constant linear velocity and the resulting light of reflection thereof is detected.

With regard to laser beam source having an oscillation wavelength of not more than 500 nm which is an optical means for recording and reproduction, laser having a wavelength within a range of 350 to 450 nm is able to be used and its examples are bluish violet semiconductor laser having an oscillation wavelength within a range of 390 to 415 nm and bluish violet SHG laser where central oscillation wavelength is 405 nm.

Back Layer

As mentioned above, in the optical information recording carrier of the present invention, a back layer is a layer which is installed on the back of a support and is a layer which is installed in a support on a side being unequipped with a light transmitting layer for such a purpose that, when the optical information recording carrier is preserved for a long period in a state of low humidity or high humidity, warp of the information recording carrier resulted by the difference in expansion coefficient upon moisture absorption between the light transmitting layer and the support is corrected. It has a plastic substrate film in which expansion coefficient is different from the support to an extent of 10 pm/% RH or more. Thus, in other words, in an optical information recording carrier, when plastic having a different expansion coefficient upon moisture absorption from a support is used as a substrate film of the light transmitting layer, asymmetry is resulted in distribution of expansion coefficient upon moisture absorption in the thickness direction and, due to that, a problem of warp is resulted when humidity is greatly changed. The asymmetry is made into symmetry again by the use of a plastic film having the same expansion coefficient upon moisture absorption as the plastic film used as a substrate in a light transmitting layer on the back whereby the problem of warp resulted by asymmetry is solved.

A back layer is equipped with the above-mentioned plastic film and also an adhesive layer or a bonding layer for adhering it to a support. When the plastic film is able to be directly adhered to a support by, for example, means of thermal adhesion, neither adhesive layer nor bonding layer is necessary. It is also possible that the back layer is equipped with a adhesive layer or a bonding layer for a plastic film and that the side which is not layered is equipped with a functional layer such as a hard coat layer or an anti-pollution layer.

With regard to a hard coat layer, the same one as for the above-mentioned light transmitting layer may be used. It is also a preferred embodiment of the present invention that, in order to secure the symmetry in the thickness direction, the layer including an adhesive layer has the same constitution as that of a light transmitting layer. Since the back layer is not necessary to transmit the light for reading the record, there is no restriction for transmittance and haze. Accordingly, it is possible depending upon necessity that the hard coat layer is colored or scattered particles are contained therein. It is also possible that an ultraviolet absorber showing absorption in a visible region is contained therein.

If necessary, it is further possible that design is enhanced by formation of a decoration layer such as a printing layer. Such a decoration layer is also able to be formed as the uppermost layer of the back layer. It is also possible to be formed between the plastic substrate film and the hard coat layer or between the plastic substrate film and the adhesive layer or the bonding layer. It is preferred that the decoration layer is formed on the area other than the outermost layer because design is able to be enhanced thereby and a decoration layer is protected from scratch. It is particularly preferred to form a transparent layer of 10 μm or more on the decoration layer because depth of the decoration layer is able to be enhanced. Usually, hard coat layer and plastic film absorb ultraviolet ray and, therefore, there is also achieved an effect of protection of the decoration layer from ultraviolet ray and the above is preferred from such a view as well.

In optical disks such as CD and DVD, it has been commonly conducted to form a label on the back side. Back side of the optical information recording carrier of the present invention is also able to be utilized as a label by enhancing design.

Specific examples of the decoration layer are a pattern ink layer and a metal thin film layer.

For example, a pattern ink layer is able to be formed by ink by means of known printing method such as gravure printing, offset printing, silk screen printing and transcription printing from transfer sheet or by means of hand writing. In the case of solid pattern on the whole surface, that is also able to be formed by a paint by means of known painting method such as gravure coat, roll coat and spray coat. With regard to the ink or the paint used therefor, that where coloring agent and other additive are appropriately added to one of or a mixture of two or more of chlorinated polyolefin (e.g., chlorinated polyethylene and chlorinated polypropylene) and resin (e.g., polyester resin, urethane resin, acrylate resin, vinyl acetate resin, vinyl chloride resin, a copolymer of vinyl chloride with vinyl acetate and cellulose resin) as an adhesive. Among those, a compound containing no chlorine is preferred in view of environment such as generation of dioxin upon burning treatment.

With regard to a coloring agent, an inorganic pigment (including dye) such as titanium white, zinc flower, carbon black, black iron, red iron oxide, Chrome Vermilion, ultramarine blue, cobalt blue, yellow lead and titanium yellow, an organic pigment (including dye) such as phthalocyanine blue, indathrene blue, isoindolinone yellow, benzidine yellow, quinacridone red, polyazo red, perylene red and aniline black, a metal pigment comprising flaky foil of aluminum, blass, etc., a pearl luster pigment (pearl pigment) comprising flaky foil such as titanium dioxide-coated mica and basic lead carbonate and the like may be used.

The decoration layer may be a metal thin film layer. Formation of the metal thin film layer is conducted by means of vacuum vapor deposition or sputtering using metal such as aluminum, chromium, gold, solver and copper. Combination thereof may be conducted as well. The metal thin film layer may be formed on the whole surface or may be formed partially in pattern.

When a metal thin film is applied to the whole surface of a support surface of a plastic substrate film of the back layer, it is possible to endow both good design and resistance to moisture and outgoing and incoming of moisture between the support and the environment upon preservation can be limited whereby warp caused by distribution of moisture resulted in the thickness direction of the support is able to be prevented. Accordingly, that is preferred.

Difference in expansion coefficient upon moisture absorption of a substrate film of the back layer and that of a support is 10 ppm/% RH or more. The more the difference in the expansion coefficient upon moisture absorption, the more an effect for correction of warp and the difference between them is preferably 20 ppm/% RH or, particularly preferably, 30 ppm/% RH or more.

On the other hand, when expansion coefficient upon moisture absorption of the plastic film of a plastic film of the back layer and that of a light transmitting layer are similar, expansion behavior to humidity agrees and the both sides of the information recording carrier are apt to be well-balanced. Accordingly, the difference between them is preferably 20 ppm/% RH or less, more preferably 10 ppm/% RH and, particularly preferably, 5 ppm/% RH or less.

Thickness of the back layer in the information recording carrier of the present invention is preferred to be thinner than the thickness of the support. The thickness is preferably 50 to 300 μm, more preferably 60 to 200 μm, still more preferably 70 to 120 μm and, particularly preferably, 70 to 90 μm.

It is preferred in view of balance on both sides of the information recording carrier that thickness of the plastic substrate film of the back layer is similar to that of the plastic substrate film of a light transmitting layer. Difference in the thickness is preferably 20 μm or less, more preferably 10 μm or less and, particularly preferably, 5 μm or less.

It is preferred in view of balance in both sides of the information recording carrier that a material of the plastic substrate film of the back layer is same as the plastic substrate film. On the other hand, in a light transmitting layer, it is necessary for recording and reproducing that light transmittance is high and optical anisotropy does not exist while, in the back layer, there is no limitation for light transmittance and optical anisotropy. It is also possible for enhancing the design in such a manner that a plastic substrate film is colored, optical scattering is increased, surface is matted or emboss treatment is applied.

It is further possible that, with regard to a plastic substrate film for a back layer, an elongated base having a high optical anisotropy which is difficult for use in a light transmitting layer is used. In general, an elongated base is less expensive and is preferred. In view of the cost, a PET base or the like is particularly preferred. A PET base has a high mechanical strength and is preferred in such a respect as well.

An adhesive layer of the back layer is also able to be layered in the same manner as in a light transmitting layer. It is also possible that dye or pigment is added to an adhesive layer to colorize whereupon the design is enhanced. Further, an ultraviolet absorber or, particularly, that having absorption terminal in visible region is also able to be contained therein.

### EXAMPLE

The present invention will now be illustrated in more detail by way of the following Examples although the present invention is not limited to those Examples.

Preparation of optical information recording carrier

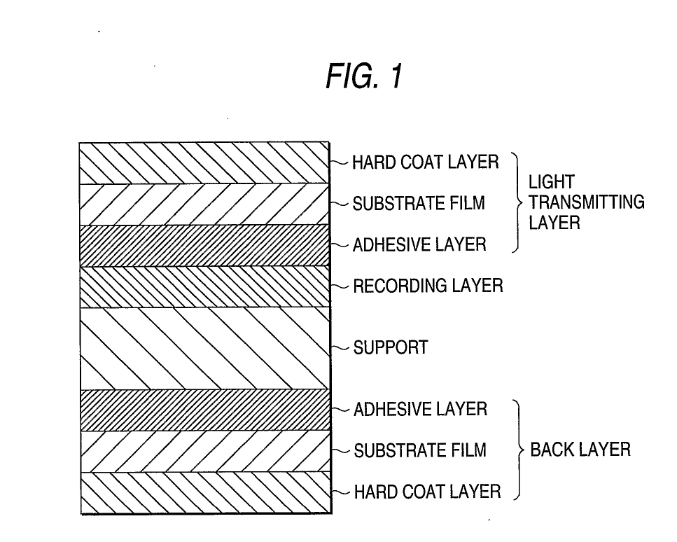

Outline of a schematic cross-sectional view of an optical information recording carrier (optical disk) prepared in this Example is shown in FIG. 1.

A. Preparation of Support and Recording Layer

Ag was sputtered on a surface having spiral grooves (depth: 100 nm; width: 120 nm; track pitch: 210 nm) and grooves of substrate (support) of injection molded polycarbonate resin of 1.1 mm thickness and 120 mm diameter (polycarbonate manufactured by Teijin; trade name: Panlite AD 5503) to form a light reflection layer having a thickness of 100 nm.

Expansion coefficient upon moisture absorption of the polycarbonate resin support prepared at that time was 12 ppm/% RH.

After that, 20 g of Orasol Blue GN (recording material 1; phthalocyanine dye; manufactured by Ciba Speciality Chemical) was added to 1 liter of 2,2,3,3-tetrafluoropropanol and dissolved by subjecting to an ultrasonic treatment for 2 hours to prepare a coating solution for formation of a recording layer. The coating solution prepared as such was applied on a light reflection layer by a spin coat method under the condition of 23° C. and 50% RH by changing the revolution within 300 to 4,000 rpm. After that, it was preserved for 1 to 4 hour(s) at 23° C. and 50% RH whereupon the film thickness of the resulting recording layer was 100 nm. ZnS—SiO₂ was sputtered on the recording layer to make its thickness 5 nm whereupon an intermediate layer (barrier layer) was formed.

As another example of a recording material, a DC and RF sputtering method was used instead of Orasol Blue GN and a layered film comprising AgPdCu/ZnSSiO/AgInSeTe/ZnSSiO (recording material 2) as a phase change recording material was formed into film was also prepared.

B. Preparation of Light Transmitting Layer (Hard Coat Film)

Here, an example for preparation of a light transmitting layer comprising adhesive layer, light transmitting film (substrate film), hard coat layer and, in some cases, anti-pollution layer will be shown. As hereunder, a method for the manufacture of a light transmitting film (cellulose acylate film and cyclic polyolefin film) which is a substrate film, application of a hard coat layer and application of an anti-pollution layer will be mentioned in this order.

1-1. Method for the Manufacture of Cellulose Acylate Film (TAC-1)

Both-terminal dihydroxypolyester of an average molecular weight of 2,125 comprising adipic acid and ethylene glycol where repeating unit is —[O—(CH₂)₂—OCO—(CH₂)₄CO]— was made to react with tolylene diisocyanate (TDI) to synthesize a polyester-urethane resin of an average molecular weight of 7,300 soluble in methylene chloride. This compound will be called PU-1. To the PU-1 was added cellulose acetate to give a dope having the following composition.

| | | |
|---|---|---|
| Cellulose triacetate | 100 | parts by weight |
| (Degree of substitution: 2.85; | | |
| degree of substitution at 6-position: 0.90) | | |
| PU-1 | 15 | parts by weight |
| Methylene chloride | 270 | parts by weight |
| Butanol | 7 | parts by weight |
| Methanol | 70 | parts by weight |

This dope was placed in a tightly-closed container and completely dissolved with stirring by keeping at 80° C. with pressure. Then the dope was filtered and cooled and, keeping at 25° C., it was flown on a rotating drum of 30 cm diameter equipped with a jacket. Because of necessity that the drum has a heat transmission property, resistance to corrosion and flatness, a Ni layer of about 50 μm was plated on a stainless steel, then about 40 μm of hard chromium plating was applied twice thereon, the surface was subjected to a super-mirror abrasion of 0.01 to 0.05 S and the resulting product was used. At that time, the drum was kept in such a manner that cold water was run into a jacket so that the surface temperature was made 0° C. The flowing velocity was fixed at 3 m/minute, the film was detached via a detaching roll at the position which was rotated at 270° from a flowing position in a flowing direction, a base was pulled at a rate of 3.15 m/minute and flown to an extent of 5% in the flowing direction. Both sides of the flown film were fixed and dried with hot air of 70° C. to give a film of 80 μm thickness. Expansion coefficient upon humidity absorption determined by measurement of the length of the film upon changing the humidity was 70 ppm/% RH.

1-2. Method for the Manufacture of Cellulose Acylate Films (TAC-2, 3, 4, 5, 6, and 7) Containing a Deterioration Preventing Agent

The same operation as in 1-1 was conducted except that a product where 1 part by weight each of the following deterioration preventing agents 1 to 5 was added to TAC-1 was used as a dope to give each of TAC-2 (to which a deterioration preventing agent 1 was added), TAC-3 (to which a deterioration preventing agent 2 was added), TAC-4 (to which a deterioration preventing agent 3 was added), TAC-5 (to which a deterioration preventing agent 4 was added), TAC-6 (to which a deterioration preventing agent 5 was added) and TAC-7 (to which a deterioration preventing agent 6 was added) having a film thickness of 80 μm. Expansion coefficients upon moisture absorption of them were 60, 43, 30, 25, 35 and 40 ppm/% RH, respectively.

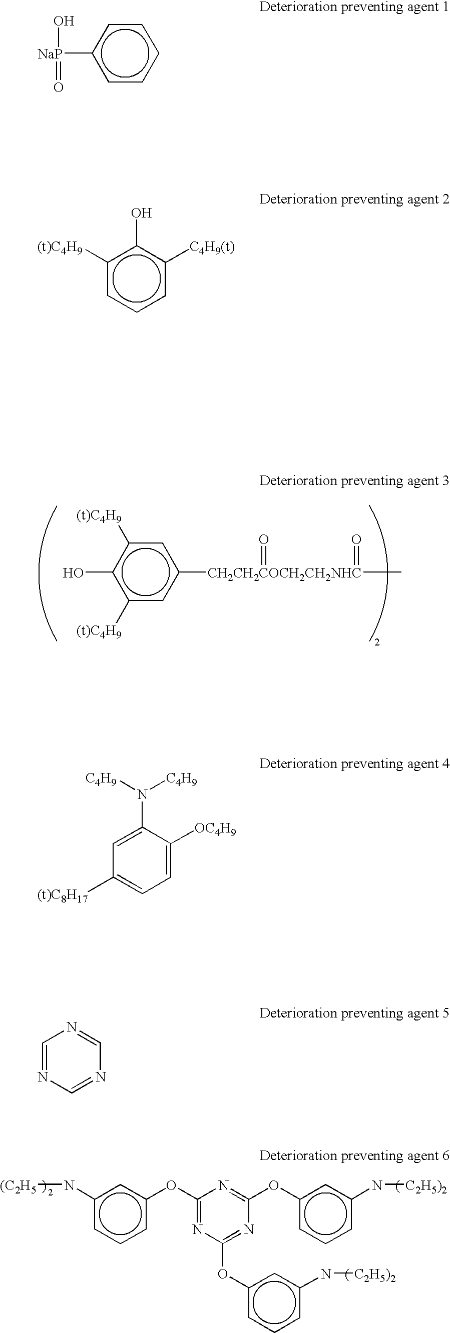

2. Formation of Hard Coat Layer

2-1. Preparation of Hard Coat Coating Solution

(1) Preparation of H-1 Solution

A mixture (450 parts by weight) (DPHA, manufactured by Nippon Kayaku) of dipentaerythritol pentaacrylate and dipentaerythriol hexaacrylate was dissolved in a mixed solvent of 210 parts by weight of isopropyl alcohol (IPA) and 140 parts by weight of methyl isobutyl ketone (MIBK). To the resulting solution was added 12.0 parts by weight of an optical polymerization initiator (Irgacure 907, manufactured by Ciba-Geigy), stirring was conducted until dissolution took place, 380 parts by weight of IPA-ST (a dispersion of SiO₂ sol in isopropyl alcohol; average particle size: 10 to 20 nm; solid concentration: 30% by weight; manufactured by Nissan Chemical Industries) and 257 parts by weight of MIBK-ST (a dispersion of SiO₂ sol in methyl isobutyl ketone; average particle size: 10 to 20 nm; solid concentration: 30% by weight; manufactured by Nissan Chemical Industries) followed by stirring and the resulting mixture was filtered through a filter made of polypropylene having a pore size of 3 μm (PPE-03; manufactured by Fuji Photo-Film) to prepare an coating solution (H-1) for a hard coat layer.

(2) Preparation of H-2 Solution

A mixture (450 parts by weight) (DPHA, manufactured by Nippon Kayaku) of dipentaerythritol pentaacrylate and dipentaerythriol hexaacrylate was dissolved in a mixed solvent of 210 parts by weight of isopropyl alcohol (IPA) and 140 parts by weight of methyl isobutyl ketone (MIBK). To the resulting solution was added 12.0 parts by weight of an optical polymerization initiator (Irgacure 907, manufactured by Ciba-Geigy), stirring was conducted until dissolution took place, 380 parts by weight of IPA-ST (a dispersion of SiO₂ sol in isopropyl alcohol; average particle size: 10 to 20 nm; solid concentration: 30% by weight; manufactured by Nissan Chemical Industries) and 257 parts by weight of MIBK-ST (a dispersion of SiO₂ sol in methyl isobutyl ketone; average particle size: 10 to 20 nm; solid concentration: 30% by weight; manufactured by Nissan Chemical Industries) followed by stirring, 0.54 part by weight of UMS-182 (Gelest) was added thereto and the resulting mixture was filtered through a filter made of polypropylene having a pore size of 3 μm (PPE-03; manufactured by Fuji Photo-Film) to prepare a coating solution (H-2) for a hard coat layer.

2-2. Preparation of Hard Coat Film (Application of Hard Coat Layer)

(1) Preparation of Hard Coat Film

The above-mentioned coating solution for hard coat layer was applied by an extrusion method to a cellulose acylate film of 80 μm (substrate film) so as to give the thickness shown in Table 1. After drying at 70° C. for 1 minute, ultraviolet ray of illuminance of 400 mW/cm² and an irradiation dose of 500 mJ/cm² was irradiated under pursing with nitrogen (oxygen concentration: 0.1% ) using an air-cooled metal halide lamp of 160 W/cm (manufactured by Ai Graphics) to harden the hard coat layer whereupon a hard coat film was rolled.

A polycarbonate film (PC) was used as a light transmitting film (substrate film) and a hard coat layer was formed on the film as follows. Thus, a polycarbonate film (Teijin Pure Ace; thickness: 80 μm; having a releasing film on one side; expansion coefficient upon moisture absorption: 12 ppm/% RH) wound in a roll was used and sent out to a predetermined coating region, a previously endowed releasing film was detached, a hard coat solution was applied to form a film and radioactive ray was continuously applied to the resulting film so that the radio-setting resin (ultraviolet-setting resin) was hardened whereupon a hard coat layer was formed.

C. Adhesion of Hard Coat Film to Substrate

A hard coat film prepared in the above B was adhered via an intermediate layer to a recording layer installed on a support in the above A to prepare an optical information recording carrier.

1. Formation of Adhesive Layer

An acrylate copolymer (solvent: ethyl acetate/toluene=1/1) and an isocyanate cross-linking agent (solvent: ethyl acetate/toluene=1/1) were mixed in 100:1 (ratio by weight) to prepare an adhesive coating solution A. This adhesive coating solution A was used to form an adhesive layer on the surface of a releasing film by an indirect method.

Together with conveying a releasing film made of polyethylene wound in a roll, an adhesive coating solution A was applied on the surface of the releasing film so as to make the thickness after drying 20 μm. After that, drying was conducted at 100° C. in a drying region to give a releasing film where an adhesive layer was installed.

2. Manufacture of Transparent Sheet for Optical Information Recording Carrier

A releasing film where an adhesive layer was formed was adhered to the side, which was another side to which a hard coat layer was formed, of a hard coat film. After that, this hard coat film where hard coat layer and adhesive layer were formed was wound again in roll and, under such a state, kept for 72 hours in an atmosphere of 23° C. and 50% RH.

Then the hard coat film where hard coat layer and adhesive layer were formed was sent out and punched in the same shape as in the above substrate. As a result, there was prepared a transparent sheet for an optical information recording carrier having an adhesive layer on one side of a light transmitting film and a hard coat layer on another side thereof.

3. Preparation of an Optical Information Recording Carrier (Adhesion of Hard Coat Film to Support and Recording Layer)

A releasing film at the side of an adhesive was detached from a transparent sheet for an optical information recording carrier in a disk shape and an intermediate layer and an adhesive layer were adhered by a compressing means to prepare an optical information carrier (optical disk). Constitution of the optical information recording carrier prepared as such is shown in Table 1.

4. Preparation of Optical Information Recording Carrier Equipped with Back Layer

Substrate film prepared in 1-1 and 1-2 and the same thing as the hard coat layer prepared in 2-1 and 2-2 were adhered as back layer to the information recording carrier prepared in 3 by a compressing means using roller to prepare an optical information recording carrier having a back layer.

E. Measurement

1. Pencil Hardness Test Moisture of a film of a light transmitting layer of a recording carrier was adjusted under the condition of 25° C. temperature and 60% relative humidity for 2 hours and pencil hardness was determined where no stab was noted by a load of 9.8 N using a pencil for the test stipulated by JIS-S-6006 according to a method for evaluation of pencil hardness stipulated by JIS-K-5400.

2. Resistance to Scratch

Surface of the side of the light transmitting layer of the recording carrier was abraded with a load of 1.96 N/cm² and the scratch which was able to be noted by naked eye was evaluated. (∘∘ is a state where no scratch was noted even abraded for 300 times; ∘ is a state where scratch was slightly noted thereby; Δ is a state where scratch was noted thereby but no scratch was noted until abrasion was conducted up to 100 times; and x is a state where scratch was noted by abrasion for less than 100 times).

3. Anti-pollution Property

A quick-drying oily ink (“Macky” (registered trade mark); manufactured by Zebra) written on the surface of the side of the light transmitting layer of the recording carrier was wiped for several times using “Toracy” (registered trade mark; manufactured by Toray) whereupon an evaluation was conducted. (∘∘ is a state that the mark was completely wiped off, ∘ is a state where the mark was mostly wiped off although remained a little; Δ is a state where the mark was not partially wiped off; and x is a state where most of the mark still remained).

4. Changes in Value of Radial Skew

The optical disks according to Examples and Comparative Examples were allowed to stand for 10 hours in a vessel where temperature and humidity were kept constant at 25° C. and 50%, respectively and radical skew was measured. After that, the disks were allowed to stand in a vessel where temperature and humidity were kept constant at 25° C. and 90% and changes when the measured value at the state where temperature and humidity were 25° C. and 50%, respectively was defined 0 were adopted as the changes in value of radial skew.

Results of various measurements for the prepared optical recording media are shown in Table 2.

TABLE 1

| | | | Substrate Film | | | | |
|---|---|---|---|---|---|---|---|
| | | | | | Difference | | |
| | | | | | between Support | | |
| | | | | | and Expansion | | |
| Optical | Recording | | | | Coefficient upon | Hard Coat | |
| Information | Layer | Adhesive | | | Moisture | Layer | |
| Recording | Recording | Thickness | | Thickness | Absorption | | Thickness |
| Carrier | Material | (μm) | Type | (μm) | (ppm/% RH) | Formulation | (μm) |
| | | Light Transmitting Layer | | | | | |
| 1 | 1 | 20 | PC | 80 | 0 | — | 0 |
| 2 | 1 | 20 | PC | 80 | 0 | — | 0 |
| 3 | 1 | 20 | PC | 80 | 0 | — | 0 |
| 4 | 1 | 20 | TAC-1 | 80 | 58 | — | 0 |
| 5 | 1 | 17 | TAC-1 | 80 | 58 | H-1 | 3 |
| 6 | 1 | 17 | TAC-1 | 80 | 58 | H-2 | 3 |
| 7 | 1 | 20 | TAC-1 | 80 | 58 | — | 0 |
| 8 | 1 | 17 | TAC-1 | 80 | 58 | H-1 | 3 |
| 9 | 1 | 17 | TAC-1 | 80 | 58 | H-1 | 3 |
| 10 | 1 | 17 | TAC-1 | 80 | 58 | H-2 | 3 |
| 11 | 1 | 17 | TAC-1 | 80 | 58 | H-2 | 3 |
| 12 | 1 | 17 | TAC-2 | 80 | 48 | H-2 | 3 |
| 13 | 1 | 17 | TAC-3 | 80 | 31 | H-2 | 3 |
| 14 | 1 | 17 | TAC-4 | 80 | 18 | H-2 | 3 |
| 15 | 1 | 20 | TAC-5 | 80 | 13 | — | 0 |
| 16 | 1 | 17 | TAC-5 | 80 | 13 | H-2 | 3 |
| 17 | 1 | 17 | TAC-5 | 80 | 13 | H-2 | 3 |
| 18 | 1 | 17 | TAC-6 | 80 | 23 | H-2 | 3 |
| 19 | 1 | 17 | TAC-7 | 80 | 28 | H-2 | 3 |
| | | Back Layer | | | | | |
| 1 | 1 | — | — | — | — | — | — |
| 2 | 1 | 20 | PC | 80 | 0 | — | 0 |
| 3 | 1 | 20 | PC | 80 | 0 | — | 0 |
| 4 | 1 | — | — | — | — | — | — |
| 5 | 1 | — | — | — | — | — | — |
| 6 | 1 | — | — | — | — | — | — |
| 7 | 1 | 20 | TAC-1 | 80 | 58 | — | 0 |
| 8 | 1 | 20 | TAC-1 | 80 | 58 | — | 0 |
| 9 | 1 | 20 | TAC-1 | 80 | 58 | H-1 | 3 |
| 10 | 1 | 20 | TAC-1 | 80 | 58 | — | 0 |
| 11 | 1 | 20 | TAC-1 | 80 | 58 | H-2 | 3 |
| 12 | 1 | 20 | TAC-2 | 80 | 48 | — | 0 |
| 13 | 1 | 20 | TAC-3 | 80 | 31 | — | 0 |
| 14 | 1 | 20 | TAC-4 | 80 | 18 | — | 0 |
| 15 | 1 | — | — | — | — | — | 0 |
| 16 | 1 | — | — | — | — | — | 0 |
| 17 | 1 | 20 | TAC-5 | 80 | 13 | — | 0 |
| 18 | 1 | 20 | TAC-6 | 80 | 23 | — | 0 |
| 19 | 1 | 20 | TAC-7 | 80 | 28 | — | 0 |

TABLE 2

| | Properties of Light Transmitting | | | | | | | | | |
|---|---|---|---|---|---|---|---|---|---|---|
| | Layer Surface | | | | Properties of Back Side | | | | Changes | |
| | | | | Contact | | | | Contact | in | |
| Optical | | Resistance | | Angle | | Resistance | | Angle | Radial | |
| Recording | Pencil | to | Anti | to | Pencil | to | Anti | to | Skew | |
| Carrier | Hardness | Scratch | pollution | Water | Hardness | Scratch | pollution | Water | (°) | Remarks |
| 1 | 4B | X | X | 85° | 4B | X | X | 85° | 0.1 | CE |
| 2 | 4B | x | x | 85° | 4B | x | x | 85° | 0.1 | CE |
| 3 | 2B | ∘∘ | ∘∘ | 100° | 4B | x | x | 85° | 0.1 | CE |
| 4 | H | x | x | 85° | 4B | x | x | 85° | 7.0 | CE |
| 5 | 2H | ∘∘ | x | 85° | 4B | x | x | 85° | 6.0 | CE |
| 6 | 2H | ∘∘ | ∘∘ | 100° | 4B | x | x | 85° | 6.0 | CE |
| 7 | 2H | x | x | 85° | H | x | x | 85° | 0.1 | Ex |
| 8 | 2H | ∘∘ | x | 85° | H | x | x | 85° | 0.2 | Ex |
| 9 | 2H | ∘∘ | x | 85° | 2H | ∘∘ | x | 85° | 0.1 | Ex |
| 10 | 2H | ∘∘ | ∘∘ | 100° | H | x | x | 85° | 0.2 | Ex |
| 11 | 2H | ∘∘ | ∘∘ | 100° | 2H | ∘∘ | ∘∘ | 100° | 0.1 | Ex |
| 12 | 2H | ∘∘ | ∘∘ | 100° | H | x | x | 85° | 0.2 | Ex |
| 13 | 2H | ∘∘ | ∘∘ | 100° | H | x | x | 85° | 0.1 | Ex |
| 14 | 2H | ∘∘ | ∘∘ | 100° | H | x | x | 85° | 0.2 | Ex |
| 15 | H | x | x | 85° | 4B | x | x | 85° | 1.0 | CE |
| 16 | 2H | ∘∘ | ∘∘ | 100° | 4B | v | | 85° | 0.5 | CE |
| 17 | 2H | ∘∘ | ∘∘ | 100° | H | x | x | 85° | 0.1 | Ex |
| 18 | 2H | ∘∘ | ∘∘ | 100° | H | x | x | 85° | 0.1 | Ex |
| 19 | 2H | ∘∘ | ∘∘ | 100° | H | x | x | 85° | 0.1 | Ex |

CE: Comparative Example
Ex: Example

It is apparent from Tables 1 and 2 as follows.

In optical information recording carriers (optical disks) in which polycarbonate is used as a substrate film for a light transmitting layer, difference in expansion coefficient upon moisture absorption from a support is little whereby changes in skew is little although there are still problems in pencil hardness, resistance to scratch, anti-pollution property and cost which was mentioned as above (optical information carriers 1 to 3). Even when a cellulose acylate film in which difference in expansion coefficient upon moisture absorption from a support is 10 ppm/% RH or more is used as a substrate film for a light transmitting layer, it goes without saying that optical information recording carriers having no substrate film on the back of a support have big changes in skew and, further, have low pencil hardness, resistance to scratch and anti-pollution property of the back (optical information recording carriers 4 to 6 and 15 to 16).

On the contrary, in the optical information recording carriers (7 to 14 and 17 to 19) of the present invention, changes in values of skew are little as same as in the optical information recording carriers 1 to 3.

Furthermore, in the optical information recording carriers (9 and 11) of the present invention in which a cellulose acylate film equipped with a hard coat layer of the present invention, pencil hardness and resistance to scratch are improved.

### INDUSTRIAL APPLICABILITY

According to the present invention, it is possible to provide an information recording carrier which has an excellent stability upon preservation, is not deteriorated in its flatness even under high temperature and high humidity, has good recording and reproducing ability and is less expensive and useful. It is also possible to provide an information recording carrier where scratch and dirt are not left on the surface and stability upon preservation is excellent. The information recording carrier of the present invention is particularly effective for an optical recording system utilizing bluish violet laser and high NA pickup.

The entire disclosure of each and every foreign patent application from which the benefit of foreign priority has been claimed in the present application is incorporated herein by reference, as if fully set forth.

1. An optical information recording carrier comprising:
a back layer;
a support;
a recording layer; and
a light transmitting layer, in this order,
wherein each of the back layer and the light transmitting layer comprises at least one substrate film,
wherein a difference between a hygroscopic expansion coefficient of the at least one substrate film and a hygroscopic expansion coefficient of the support is 10 ppm/% RH or more.

2. The optical information recording carrier according to claim 1, wherein the difference is 30 ppm/% RH or more.

3. The optical information recording carrier according to claim 1, wherein the light transmitting layer has a thickness of 50 μm to 300 μm.

4. The optical information recording carrier according to claim 1, wherein the recording layer is recorded by a light having a wavelength of 350 nm to 450 nm.

5. The optical information recording carrier according to claim 1, wherein the support comprises a material containing a polycarbonate.

6. The optical information recording carrier according to claim 1, wherein at least one of the at least one substrate film is a cellulose acylate film.

7. The optical information recording carrier according to claim 1, wherein at least one of the at least one substrate film contain(s) at least one deterioration preventing agent selected from
(A) a decomposing agent for peroxide,
(B) a radical chain terminator,
(C) a metal inactivating agent and
(D) an acid capturing agent.

8. The optical information recording carrier according to claim 1, wherein the light transmitting layer further comprises a hardened film containing a resin hardened by active energy ray in a surface of the light transmitting layer.

9. The optical information recording carrier according to claim 1, wherein the back layer further comprises a hardened film containing a resin hardened by active energy ray in a surface of the back layer.

10. The optical information recording carrier according to claim 8, wherein the hardened film contains inorganic particles having an average particle size of 5 nm to 200 nm.

11. The optical information recording carrier according to claim 1, wherein a contact angle between the surface of the light transmitting layer and a water is 90° or more.

12. The optical information recording carrier according to claim 1, wherein a pencil hardness of the surface of the light-transmitting layer is H or more.

13. An optical information recording method which comprises recording an information signal to a recording layer of an optical information recording carrier according to claim 1 by using a light having a wavelength of 350 nm to 450 nm.

14. An optical information reproduction method which comprises reproducing an information signal from a recording layer of an optical information recording carrier according to claim 1 by using a light having a wavelength of 350 nm to 450 nm.
